(19) United States
(12) Patent Application Publication
(10) Pub. No.: US 2026/0042344 A1
(43) Pub. Date: Feb. 12, 2026

(54) MONITORING LIQUID VOLUME IN A CONTAINER

(71) Applicant: ODYSIGHT.AI LTD., Omer (IL)

(72) Inventors: Amir GOVRIN, Ramat Gan (IL); Yekaterina DLUGACH, Mabuim (IL); Arik PRIEL, Givat Shmuel (IL); Yishaia ZABARY, Tel Aviv (IL); Gilad SENDEROVICH, Petach Tikva (IL)

(21) Appl. No.: 18/995,821

(22) PCT Filed: Jun. 15, 2023
(86) PCT No.: PCT/IL2023/050624

§ 371 Date: Jan. 16, 2025

Related U.S. Application Data
(60) Provisional application No. 63/394,166, filed on Aug. 1, 2022.

(51) Int. Cl. B60K 15/03; G01F 23/292

(52) U.S. Cl. CPC B60K 15/03; G01F 23/292; B60K 2015/03217

(57) ABSTRACT

A system for monitoring a liquid volume includes processing circuitry. The processing circuitry inputs at least one image of a liquid contained in a container from one or more optical sensors. The volume of the liquid in the container is estimated from the input image(s). The estimated liquid volume is analyzed to determine whether it is consistent with an expected liquid volume. The analysis may be based on a single estimated liquid volume or multiple liquid volumes (for example liquid volumes estimated from images captured at different respective times). An indicator is output based on the results of the analysis.

### TECHNICAL FIELD

The present disclosure, in some embodiments, thereof, relates to monitoring the volume of a liquid, and, more particularly, but not exclusively, to monitoring the volume of a liquid in a container.

### BACKGROUND

Accurately measuring the amount of liquid in a container, such as a fuel tanks, oil tanks, water tanks, storage tanks, and so forth, is required in many industries. Proper estimation of liquid volume may be critical, for example, in vehicles, aerospace and machinery where incorrect levels of liquids can lead to immediate or future failures. The need for accurate monitoring of liquid volume spans many industries, such as chemical plants, the pharmaceutical industry, and water purification plants.

Due to the difficulties in accurately estimating the liquid volume, industrial maintenance is typically based on other factors. For example, industrial maintenance may be performed periodically at set intervals of time (periodic maintenance), be based on statistical and/or historic data, based on a certain level of use (for example mileage or a number of engine hours), or when a machine, part or component fails (breakdown maintenance). This type of maintenance is often wasteful and inefficient.

Monitoring liquid volume is particularly difficult when the container is in motion. The motion may cause the liquid surface to tilt, form bubbles and waves or change rapidly, making customary techniques for evaluating the liquid surface imprecise.

Therefore, there is a need for a system which provides constant monitoring of liquid volume to provide an accurate measurement of the amount of liquid present in the container.

### SUMMARY OF THE INVENTION

According to some embodiments there is provided a system, a method, and a computer program product for detecting the volume of a liquid in a container (also denoted herein the liquid volume).

Embodiments of the invention presented herein utilize image analysis in order to estimate the volume of a liquid within a container. The images are provided by one or more optical sensors, capturing images of respective sections of the container through which the liquid may be viewed. Portions of the image which show the presence of the liquid in the container are used to estimate the volume of the liquid in the container. The estimation of the liquid volume may be performed by a geometrical analysis based on the dimensions of the container and/or using a model of the container.

Information about the volume of a liquid is extremely significant for predictive maintenance systems such as Prognostic Health Management (PHM), Condition-based Maintenance (CBM) and Health & Usage Monitoring Systems (HUMS). Unexpected changes in the liquid volume may indicate improper operation of the container itself and/or an element associated with the container. For example, the fuel consumption for a particular aircraft flight may be expected to be within a certain range. If the change in liquid volume is greater than an expected range, this may indicate a leak in the fuel system which may be extremely dangerous. In another example, a slow decrease in liquid volume may indicate a possible deterioration in a gasket or tube which should be inspected at the next scheduled maintenance. In another example, an inconsistent increase in liquid volume may indicate a blockage in the liquid flow path.

As used herein, according to some embodiments of the invention, the terms “element associated with the container” and “associated elements” mean any element whose performance and/or health is affected by the liquid volume. Examples of such elements may include but are not limited to peripheral components, machines, vehicles, mechanisms and/or other types of systems not explicitly listed here.

As used herein, according to some embodiments of the invention, the terms “volume of liquid in the container” and “liquid volume” means the volume of the liquid within the container. In some cases there is knowledge of the volume of liquid which is in the system but is not currently in the container. In such cases, the total liquid volume may be calculated as a sum of the two volumes (or by another calculation).

Embodiments of the invention provide a technical solution to the technical problem of estimating the volume of a liquid in a container. The liquid volume may be estimated using image analysis, thereby obtaining greater accuracy than current mechanical liquid measurement techniques such as a using a float. Monitoring the liquid volume accurately and over time, may enable identifying and/or predicting a fault before it has become acute. Thus the occurrence of such faults may be avoided by preventive maintenance.

Effects of the invention may include but are not limited to:
1) Rapid detection of acute failures;
2) Preventive and predictive maintenance may be based on the progression of the liquid volume values over time;
3) Suitable for monitoring many types of systems and devices, including manufacturing machinery, vehicles, aircrafts, climate control systems, laboratory equipment and many more.
4) May be used in a wide range of environmental conditions (e.g. over a wide temperature range).
5) Suitable for use during motion and when subjected to forces that may cause rapid changes in the liquid and the liquid surface, such as vibration, turbulence and splashes.
6) Real time detection of liquid volume during operation of machine and thereby providing real time preventive and predictive maintenance of the machine during operation thereof.
7) Enables liquid volume measurement in otherwise inaccessible areas which may require high efforts to be examined/maintained, by positioning the optical sensor(s) within or in sight of a container that may not be monitored otherwise

According to a first aspect of some embodiments of the present invention there is provided a system for monitoring a liquid volume. The system includes, a processing circuitry configured to:
input at least one image of a liquid contained in a container from at least one optical sensor;
estimate, from the at least one image, a volume of the liquid in the container; and
output an indicator of a consistency of the estimated liquid volume with an expected liquid volume based on an analysis of the estimated volume of the liquid.

According to a second aspect of some embodiments of the present invention there is provided method for monitoring a liquid volume, comprising:
inputting at least one image of a liquid contained in a container from at least one optical sensor;
estimating, from the at least one image, a volume of the liquid in the container; and
outputting an indicator of a consistency of the estimated liquid volume with an expected liquid volume based on an analysis of the estimated volume of the liquid.

According to a third aspect of some embodiments of the present invention there is provided a non-transitory storage medium storing program instructions which, when executed by a processor, cause the processor to carry out the method of the second aspect.

According to some embodiments of the invention, the images are input from a plurality of optical sensors capturing images of the container with respective fields of view.

According to some embodiments of the invention, the indicator includes an assessment of a health of at least one of:
a) the container;
b) a machine utilizing the liquid;
c) a vehicle utilizing the liquid;
d) a mechanism utilizing the liquid;
e) a heating, ventilation and air conditioning (HVAC) system; and
f) a peripheral component.

According to some embodiments of the invention, the indicator includes at least one of:
a) the estimated liquid volume;
b) a rate of change of the liquid volume over time;
c) a prediction of a future liquid volume;
d) at least one of a frequency and an amplitude of a liquid fluctuation in the container;
e) a color change of the liquid;
f) a change in opacity of the liquid;
g) a change in clarity of the liquid;
h) a change in viscosity of the liquid;
i) a presence of particles in the liquid;
j) maintenance instructions;
k) a time to failure estimation;
l) a failure alert; and
m) operating instructions in response to a detected failure.

According to some embodiments of the invention, the estimating includes analyzing a distribution of intensities in at least one channel of the at least one image and identifying pixels having a distribution consistent with a presence of a liquid.

According to some embodiments of the invention, the estimating includes eliminating pixels distant from a main volume of the liquid from a calculation of the liquid volume.

According to some embodiments of the invention, the estimating includes calculating the liquid volume based on a geometrical analysis of a container shape.

According to some embodiments of the invention, the estimating is based on a statistical analysis of a sequence of images.

According to some embodiments of the invention, the estimating is further based on data obtained from non-optical sensors.

According to some embodiments of the invention, the estimating is further based on data obtained from external sources.

According to some embodiments of the invention, selection of an indicator for output is based on the current liquid volume.

According to some embodiments of the invention, the analysis is based on a change of the liquid volume over time.

According to some embodiments of the invention, the analysis is based on a trend analysis of changes in the liquid volume over time.

According to some embodiments of the invention, the at least one image shows at least two sides of the container.

According to some embodiments of the invention, the at least one image shows a section of the container, the section being wide enough to estimate a three-dimensional angle of the liquid relative to the container.

According to some embodiments of the invention, the at least one optical sensor is configured to capture the at least one image while the container is in motion relative to the ground.

According to some embodiments of the invention, at least one optical sensor is located outside the container.

According to some embodiments of the invention, at least one optical sensor is located inside the container.

According to some embodiments of the invention, the indicator is retrieved from a data structure using values of at least one of:
a) the estimated liquid volume;
b) a rate of change of the liquid volume over time;
c) a prediction of a future liquid volume; and
d) a prediction of a variation in the rate of change of the liquid volume over time.

According to some embodiments of the invention, the analysis is based on a machine learning model trained with a training set comprising at least one of:
a) images collected during periods of non-usage of the liquid;
b) images collected of a similar container during periods of usage;
c) images collected of a similar container during periods of non-usage;
d) images collected of a different container in a similar machine during periods of usage;
e) images collected of a different container in a similar machine during periods of non-usage;
f) images of other components; and
g) non-image data associated with some or all of the images in the training set.

According to some embodiments of the invention, the machine learning model is a neural network.

According to some embodiments of the invention, training of the machine learning model is performed using a supervised learning algorithm.

According to some embodiments of the invention, training of the machine learning model is performed using an unsupervised learning algorithm.

According to some embodiments of the invention, the training set includes non-image data associated with at least some of the images in the training set.

According to a fourth aspect of some embodiments of the present invention there is provided a system and method for monitoring volume of liquid and/or a change in a volume of liquid in a container and/or a rate of change of the volume of the liquid in the container.

Optionally the system includes an optical sensor. According to some embodiments the optical sensor may be a camera.

According to some embodiments the container may be in motion, for example when the container is conveyed by a moving vehicle or aircraft.

According to some embodiments of the present invention there is provided a system for monitoring volume of liquid and/or a change in a volume of liquid in a container. The system may include:
one or more optical sensors which may be configured to monitor a surface and/or contours of a liquid in a container; and
at least one processor which may be in communication with the one or more optical sensors.

The processor may be configured to:
receive one or more signals from the optical sensor(s), where the received one or more signals include one or more images of at least part of the surface of the liquid and at least a surrounding section of a perimeter of the container; and
estimate a volume and/or a change in volume of the liquid in the container based at least on the image(s) and on one or more known parameters characterizing the container and/or the liquid.

According to some embodiments, at least one of the one or more optical sensors is located outside the container. Optionally, at least a part of the container is at least partially transparent to the optical sensor(s). Optionally, the liquid is optically distinguishable from the container in the image(s). Optionally, the container includes at least one window.

Optionally, at least one of the optical sensor(s) is positioned at a respective field of view from the liquid surface. Optionally, the field of view passes through the at least one window.

Optionally, at least one of the optical sensor(s) is located inside the container. Optionally, at least one of the optical sensor(s) is mounted on an interior surface of the container. Optionally, at least a portion of the interior surface of the container is a lens of the optical sensor.

Optionally, at least one of the optical sensor(s) is at least partially immersed in the liquid.

According to some embodiments, the container include a main vessel and one or more secondary communicating vessels which may be in liquid communication with each other. Optionally, the optical sensor(s) may be positioned at respective fields of view from the liquid surface of the secondary container.

According to some embodiments, the processor may be further configured to compute a change in level of the liquid surface. Optionally, the processor may be further configured to compute a rate of change in level of the liquid surface.

According to some embodiments, the processor may be configured to receive parameters characterizing the motion of the vehicle, machine and/or mechanism. Optionally, the processor may take into account the motion parameters in estimating the volume and/or change in the volume of liquid. Optionally, the processor may be in communication with one or more motion related sensors. Optionally, the motion parameters are received from the motion sensor. Optionally, the one or more motion related sensors may include an accelerometer, navigation system (e.g., GPS), gyroscope, magnetometer, magnetic compass, hall sensor, or tilt sensor inclinometer spirit level.

According to some embodiments, the container may be located in a vehicle, machine and/or mechanism configured for motion. Optionally, the motion may be linear, rotary or a combination thereof. According to some embodiments, the processor may be configured to instruct the optical sensor(s) to acquire the image(s) upon indication that the vehicle is traveling at a constant velocity and/or in a straight and level motion.

According to some embodiments, the optical sensor(s) may include a camera. Optional types of optical sensors include but are not limited to: a charge-coupled device (CCD), a light-emitting diode (LED) and/or a complementary metal-oxide-semiconductor (CMOS) sensor. Optionally, the optical sensor(s) include one or more lenses, fiber optics or a combination thereof.

Optionally, the one or more images may include a portion of an image, a set of images, one or more video frames or any combination thereof. Optionally, the system may include at least one illumination source configured to illuminate the container or part thereof.

According to some embodiments, the one or more known parameters characterizing the container and/or the liquid may include container shape and dimensions, scale markings, expected flow rate of liquid to or from the container, duration of operation of the since the container was last filled, liquid type, liquid viscosity, liquid color, ambient temperature and/or pressure.

Note that some parameters characterizing the container and/or the liquid may vary based on environmental conditions and/or other factors. For example, liquid viscosity is affected by temperature. Thus data from a thermal sensor in the liquid or in the vicinity of the container may improve the accuracy of the determination of the liquid volume when viscosity is one of the parameters used to make the determination.

According to some embodiments, determination of a volume and/or a change in volume of the liquid in the container may include:
receiving one or more signals from at least one optical sensor which may be configured to monitor a surface of a liquid in a container and at least a surrounding section of a perimeter of the container, wherein a received signal may be at least one image including at least 3 different dimensions which may allow definition of a relative liquid plane between the container and the liquid; and
utilizing the defined liquid plane relative to a horizontal plane of the container and one or more known parameters characterizing the container to neutralize plane angle and/or acceleration effects, wherein the known parameters characterizing the container may include container dimensions, scale markings or both.
   Thereby the volume of liquid and/or a change in a volume of liquid in a container located in a vehicle, machine and/or mechanism in motion may be estimated.

According to some embodiments, the processor may be further configured to apply an algorithm configured to classify whether the estimated volume of the liquid and/or the change in the volume of liquid in the container conform to a pre-determined or pre-calculated expected liquid volume and/or change in volume which may be associated with a particular time point or level of use, and to output a signal indicative of any discrepancies therefrom.

According to some embodiments, the processor may be further configured to apply the at least one determined change to an algorithm, for an estimated volume and/or change in volume of the liquid in the container. The algorithm may analyze the determined change and classify whether the determined change may be associated with a mode of failure of the container or a vehicle including the container. If yes, the identified change is labeled as a detected fault. Optionally, for a determined change which is classified as being associated with a mode of failure, a signal indicative of the determined change associated with the mode of failure is output.

As used herein, according to some embodiments, the term “fault” may refer to an anomaly or undesired effect or process in the container and/or liquid and/or associated elements that may or may not develop into a failure but requires follow-up, to analyze whether any components should be repaired or replaced. According to some embodiments, the fault may include, among others, structural deformation, surface deformation, a crack, crack propagation, a defect, inflation, bending, wear, corrosion, leakage, a change in color, a change in appearance and the like, or any combination thereof.

As used herein, according to some embodiments of the invention, the term “failure” may refer to any problem that may cause the container and/or liquid and/or associated elements to not operate as intended. In some cases a failure may disable usage of container and/or liquid and/or associated elements or even pose a danger to the associated element or user.

As used herein, according to some embodiments of the invention, the term “failure mode” is to be widely construed to cover any manner in which a fault or failure may occur, such as structural deformation, surface deformation, a crack, crack propagation, a defect, inflation, bending, wear, corrosion, leakage, a change in color, a change in appearance, turbulence, bubbles in the liquid, and the like, or any combination thereof. It is appreciated that a part may be subject to a plurality of failure modes, related to different characteristics or functionalities thereof.

Some failure modes may be common to different element types, while others may be more specific to one or more element types. For example, cracks may be relevant to a container, bending may be relevant to a connecting tube and a failure mode of corrosion may be relevant to aluminum parts of the system.

For example, a failure mode of liquid in a container according to embodiments of the present invention may encompass a change in liquid level. A fault would be a small change in the expected liquid level, i.e. about 10 ml change, and a failure would be a severe change in expected liquid level, such as a 1.5 liter change.

According to some embodiments, a failure mode refers to the scale/range developing between a fault and an actual failure, i.e., the state of the detected change (wherein initially the detected change is defined/determined as a fault) ranging from a fault into the actual failure. According to some embodiments, the failure mode may include, among others, a detectable (e.g., exposed) visual failure indicator.

Optionally, for a detected fault, at least one model of a trend of the identified fault generated. Optionally, the trend model may include a rate of change in the fault.

Optionally, the processor may be further configured to alert a user of a predicted failure based, at least in part, on the generated model. Optionally, alerting the user of a predicted failure may include any one or more of a time or range of times of a predicted failure, a usage time of the element and characteristics of the mode of failure, or any combination thereof.

According to some embodiments, the processor may be further configured to output a prediction of when the detected fault is likely to lead to failure of the container or a vehicle including the container, based at least in part, on the generated model. Optionally, the prediction of when a failure is likely to occur may be based, at least in part, on known future environmental parameters.

According to some embodiments, generating the at least one model of trend in the detected fault may include calculating a correlation of the rate of change of the fault with one or more environmental parameters. Optionally, the one or more environmental parameters may include but are not limited to: temperature, season or time of the year, air pressure, time of day, hours of operation of the system, duration of operation of the since the container was last filled, duration of operation of the since the container was last checked, an identified user, GPS location, mode of operation of the system, or any combination thereof.

According to some embodiments, obtaining data associated with faults detection parameters of at least one mode of failure of the element includes data associated with a location of the fault and/or a specific type of mode of failure. Optionally, obtaining data associated with fault detection parameters of at least one mode of failure of the container or a vehicle including the container includes receiving input data from a user. Optionally, obtaining data associated with fault detection parameters of at least one mode of failure of the element may include identifying a previously unknown failure mode by applying the plurality of images or part thereof and/or volume change values to a machine learning algorithm configured to determine a mode of failure of the container or a vehicle including the container.

According to some embodiments, the fault may include a leak, evaporation, unexpected consumption, suspected unauthorized use or any combination thereof.

According to some embodiments, monitoring the volume of liquid and/or a change in a volume of liquid in a container may allow analysis of one or more parameters which may indicate a condition of the machine using the liquid. In a first example, when the liquid is engine oil and the monitoring is of engine oil consumption, the analysis may be used to detect oil burning issues, worn valve seals and/or piston rings and/or leakages. In a second example, when the liquid is coolant and the monitoring is of machine or system coolant consumption, the analysis may be used to detect an overheated machine, leakage of the cooling system, a damaged radiator, an open radiator cap, blocked tubing and/or nozzles.

According to a fifth aspect of some embodiments of the present invention there is provided a method for monitoring volume of liquid and/or a change in a volume of liquid in a container. The method includes:
monitoring a surface of a liquid in a container with optical sensor(s) configured to monitor; and
communicating between the optical sensor(s) and at least one processor, the processor being configured for:
   receiving one or more signals from the optical sensor(s), wherein the received signal includes one or more images of at least part of the surface of the liquid and at least a surrounding section of a perimeter of the container; and
   estimating a volume and/or a change in volume of the liquid in the container based at least on the one or more images and on one or more known parameters characterizing the container and/or the liquid.

According to some embodiments, estimating a volume and/or a change in volume of the liquid in the container may include:
receiving one or more signals from at least one optical sensor configured to monitor a surface of a liquid in a container and at least a surrounding section of a perimeter of the container, wherein a received signal is at least one image including at least three different dimensions allowing definition of a liquid plane between the container and the liquid; and
utilizing the defined liquid plane relative to a horizontal plane of the container and one or more known parameters characterizing the container to essentially neutralize plane angle and/or acceleration effects, thereby estimating the volume of liquid and/or a change in a volume of liquid in a container located in a vehicle, machine and/or mechanism in motion.
   The known parameters characterizing the container may include but are not limited to container dimensions and/or scale markings.

According to some embodiments, the processor may be further configured for applying an algorithm configured for classifying whether the estimated volume of the liquid and/or the change in the volume of liquid in the container conform to a pre-determined or pre-calculated expected liquid volume and/or change in volume associated with a particular time point or level of use, and outputting a signal indicative of any discrepancies therefrom. Optionally, the algorithm is capable of minimizing or eliminating effects such as splashes and/or turbulence in the liquid when estimating the liquid volume.

Optionally, at least one optical sensor has processing capabilities (e.g. and embedded sensor) and performs at least some of the processing described herein.

According to some embodiments, the processor may be further configured, for an estimated volume and/or change in volume of the liquid in the container, to apply the at least one determined change to an algorithm for analyzing the determined change and for classifying whether the determined change is associated with a mode of failure of the container or a vehicle including the container. The identified change may be labeled as a detected fault. For a determined change which is classified as being associated with a mode of failure, a signal indicative of the determined change associated with the mode of failure is output.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g. using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIGS. 1A-1B are simplified block diagrams of a system for monitoring the volume of a liquid, in accordance with respective embodiments of the present invention;

FIGS. 2A-2C are simplified illustrations of imaging a transparent or semi-transparent container containing respective quantities of liquid;

FIG. 2D is a simplified illustration of imaging a container having windows through which the liquid may be detected;

FIGS. 3A-3B are simplified illustrations of optical sensors located within the container, according to exemplary embodiments of the invention;

FIG. 4A is a simplified isometric representation of an exemplary tilted rectangular container containing a liquid;

FIGS. 4B-4C are simplified examples of images of respective faces of a tilted container having a flat liquid surface;

FIG. 4D is a simplified example of an image of a face of a container containing wavy liquid;

FIG. 4E is a simplified example of an image of a face of a container containing turbulent liquid;

FIG. 5 is a simplified flowchart of method for monitoring a liquid volume, according to embodiments of the invention;

FIG. 6 is a simplified schematic illustration of a system for monitoring potential failure in a container and/or associated component, in accordance with some embodiments of the present invention;

FIG. 7 is a simplified flowchart of a method for monitoring potential failure in a container and/or associated component, in accordance with some embodiments of the present invention;

FIG. 8 is a simplified schematic diagram of a method for monitoring potential failure, in accordance with some embodiments of the present invention;

FIGS. 9-10 are simplified block diagrams of the system for monitoring liquid level in communication with a cloud storage module, in accordance with respective exemplary embodiments of the present invention;

FIG. 11 is a simplified isometric representation of an exemplary rectangular container containing a liquid;

FIG. 12 is a simplified illustration of imaging a container having a window; and

FIG. 13 is a simplified illustration of imaging an exemplary the container which includes a main vessel and a secondary vessel.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to monitoring the volume of a liquid, and, more particularly, but not exclusively, to monitoring the volume of a liquid in a container.

Many types of systems require liquids such as lubricants, fuel, coolants and raw materials for proper operation. These liquids are often stored in containers which supply the liquid to an associated system (or other associated element). Maintaining the correct amount of liquid in the system may be critical. It is therefore desirable to monitor the liquid volume in any system that may lose and/or gain liquids, due to factors such as leakage, evaporation, adsorption, liquid addition and so forth.

Embodiments presented herein enable accurate and long-term monitoring of liquid in a container. The results may be used to detect immediate problems with the container and/or the monitored system, such as a rapid drop in liquid volume which may indicate damage to the container, peripheral elements or other system components.

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Embodiments of the invention presented herein include a system (also denoted herein a monitoring system) for estimating the volume of a liquid in a container using one or more images of the container or portions thereof. The images of the container are provided by one or more optical sensors to a processing circuitry. The processing circuitry determines the volume of the liquid in the container by analyzing the image(s), as described in more detail below. An indicator of the consistency of the estimated liquid volume to the expected liquid volume is output. Inconsistencies may be indicative of a problem that requires an immediate or future response.

As used herein, according to some embodiments of the invention, the term “optical sensor” mean a device which senses an optical signal and outputs an image.

As user herein, according to some embodiments of the invention, term “optical signal” encompasses ultraviolet (UV), visible and infrared (IR) radiation and electromagnetic radiation in other frequency bands.

As used herein, according to some embodiments of the invention, the term “estimating the liquid volume” and similar terms mean to determine a liquid volume that is expected to be equal to or close to the actual liquid volume.

As used herein, according to some embodiments of the invention, the term “estimated liquid volume” means the result of the estimation.

As used herein, according to some embodiments of the invention, the term “image” means any output of the optical sensor, including images and/or image data and/or another signal which may be processed to estimate the liquid volume (e.g. an electrical signal).

In some embodiments, the image(s) (e.g. image data) are provided by a single optical sensor. In alternate embodiments, the image(s) are input from multiple optical sensors capturing images of the container from different respective fields of view.

Optionally, multiple images are analyzed in order to obtain a more accurate determination of the liquid volume at a single point in time (by correlating images of different sections of the container) and/or to obtain information about changes in the liquid volume over time.

By monitoring the liquid volume over time, slow changes in the liquid volume may be detected. These slow changes may indicate a slow leak or aging of a peripheral component. Additionally, a change in liquid volume (increase or decrease) may indicate a fault in a peripheral component or other associated element. The temporal data may be reset periodically to avoid accumulating errors.

Accurate monitoring of the liquid level over time may also be of great use for predictive maintenance by ensuring, for example, that a leak is repaired or components are replaced before the problem becomes acute, e.g. before the fault becomes a failure. Furthermore, the protocols for responding to information about the current liquid level and/or changes in the liquid level may be updated periodically based on knowledge accumulated for the same or similar systems.

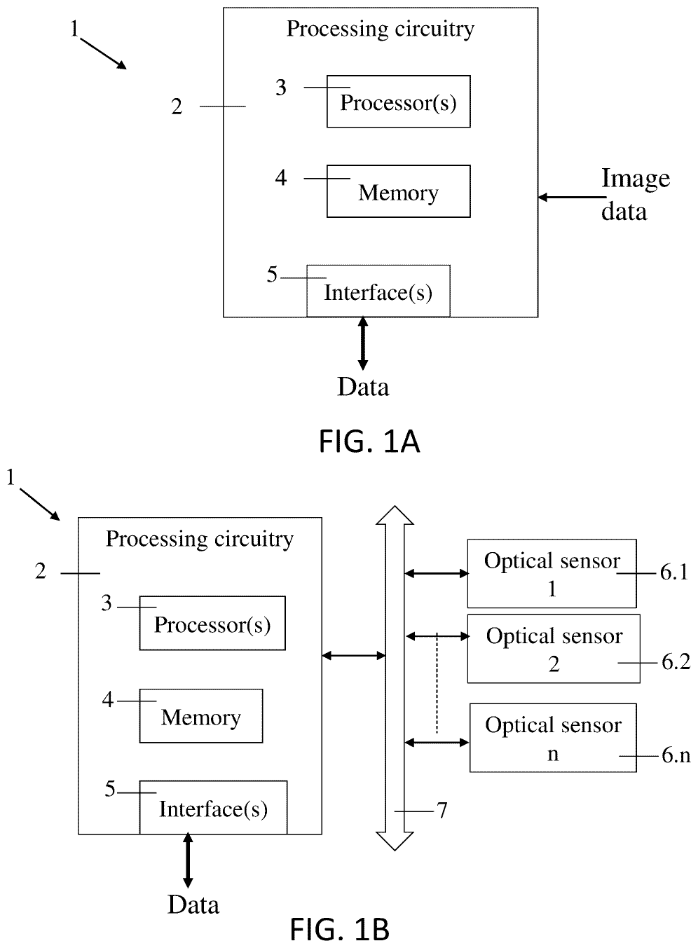

Reference is now made to FIGS. 1A-1B, which are simplified block diagrams of a monitoring system for monitoring the volume of a liquid, in accordance with respective embodiments of the present invention.

As described below, embodiments of the monitoring system may be employed for many purposes including but not limited to:
1) Monitoring the health of the container containing the liquid;
2) Monitoring the functioning and/or health of an associated element (e.g. mechanism, machine, vehicle, aircraft, HVAC system etc.);
3) Identifying faults in peripheral components of the container (e.g. hoses, tubes, gaskets, connectors, seals, etc.);
4) Predicting potential failure of the associated element or peripheral component; and
5) Determining when maintenance is or will be required for the container, peripheral component, mechanism, machine, vehicle, aircraft etc.

As used herein, according to some embodiments, the term “health” of an element (such as container, machine, peripheral components, etc.) means the overall state, functionality and condition of that specific element. It encompasses the evaluation and monitoring of various operational parameters, metrics or data points that indicate the element's current status, performance and ability to operate as intended within the industrial system.

In some embodiments, at least some of the operational parameters, metrics and/or data points used to evaluate the health of an element are based on instructions and/or guidelines provided by a manufacturer, user etc.

In accordance with the embodiments of FIG. 1A, monitoring system 1 for monitoring a liquid volume includes processing circuitry 2. Processing circuitry 2 includes one or more processors 3, and optionally additional electronic circuitry. Processor(s) 3 process the image(s) and perform the analyses described herein. Processor(s) 3 may also perform other tasks, such as providing a graphical user interface (GUI) to a user and processing inputs from the GUI and/or other input/output means.

Optionally, the processing circuitry is in communication with the optical sensor(s) by wireless communication (e.g., Bluetooth, cellular network, satellite network, local area network, etc.) and/or wired communication (e.g., telephone networks, cable television or internet access, and fiber-optic communication, etc.).

In some embodiments, processing circuitry 2 is located at a single location as shown for clarity in FIGS. 1A-1B.

In alternate embodiments, the processing circuitry is distributed in multiple locations. Optionally, at least one optical sensor includes processing circuitry which performs at least some of the processing described herein.

Optionally, some or all of the processing circuitry is located remotely, for example in a control room monitoring machines in a factory.

Optionally monitoring system 1 further includes memory 4 for internal storage of data for use by monitoring system 1. The stored data may include but is not limited to:
a) Image(s);
b) Data associated with the image(s). Examples of associated data may include but are not limited: to the time of image capture, environmental conditions at time of image capture, velocity of vehicle conveying the container and other parameters;
c) Program instructions;
d) Algorithms and rules for monitoring a liquid volume; and
e) A model of the mechanism, optionally developed by machine learning from a training set of images of the mechanism or similar mechanism(s). For example, the model may input images of the container and output the current liquid volume, the health of the container, the health of an element utilizing the liquid and/or on the liquid flow path, a failure alert, maintenance instructions, etc.

Optionally, processing circuitry 2 further includes one or more interface(s) 5 for inputting and/or outputting data. For example, the interface may serve to input image(s) and/or communicate with other components in a machine and/or to communicate with external machines or systems and/or to provide a user interface.

In one example, indicators and information about the liquid volume, container health and so forth are provided via interface(s) 5 to a HUMS, CBM or similar system.

In accordance with the embodiments of FIG. 1B, monitoring system 1 further includes one or more optical sensors 6.1-6.n, which provide the image(s) used to monitor the liquid volume. Optionally, optical sensors 6.1-6.n provide the image(s) to the processor over databus 7.

According to some embodiments, optical sensors 6.1-6.n may include a camera. According to some embodiments, optical sensors 6.1-6.n may include an electro-optical sensor. According to some embodiments, optical sensors 6.1-6.n may include any one or more of a charge-coupled device (CCD), a light-emitting diode (LED) and a complementary metal-oxide-semiconductor (CMOS) sensor (or an active-pixel sensor), a photodetector (e.g. IR sensor or UV sensor) or any combination thereof. According to some embodiments, optical sensors 6.1-6.n may include any one or more of a point sensor, a distributed sensor, an extrinsic sensor, an intrinsic sensor, a through beam sensor, a diffuse reflective sensor, a retro-reflective sensor, or any combination thereof.

Optionally, processing circuitry 2 controls one or more light sources, where each light source illuminates at least a portion of the mechanism. Optionally, each light source is focused on a specific component or reference point, which may enable reducing the required intensity of the light.

Alternately or additionally, the light source(s) are controlled by a user.

Optionally, the wavelength of the light source may be controlled by processing circuitry 2 and/or a user.

Optionally, the light sources may be configured to illuminate the container, the liquid, the liquid surface, or parts thereof.

By controlling the light sources, processing circuitry 2 and/or the user may improve the image characteristics to ease image processing and analysis. For example, a light source may be adjusted to increase contrast between the container and the liquid in the container. Alternately or additionally, a light source may be adjusted to ease detecting faults and/or surface defects and/or structural defects by increasing shadows that highlight such areas.

According to some embodiments, the light source(s) include one or more of: a light bulb, a light-emitting diode (LED), a laser, an electroluminescent wire, and light transmitted via a fiber optic wire or cable (e.g. from an LED coupled to the fiber optic cable). Other types of light sources may also be suitable.

Optionally, processing circuitry 2 controls one or more of:
1) The direction of illumination of the light source;
2) The duration of illumination;
3) The frequency of illumination;
4) The illumination intensity; and
5) Switching the light source on or off.

According to some embodiments, the light source may emit visible light, infrared (IR) radiation, near IR radiation, ultraviolet (UV) radiation or light in any other spectrum or frequency range.

According to some embodiments, a light source is a strobe light or a light source configured to illuminate in short pulses. According to some embodiments, the light source may be configured to emit strobing light without use of a shutter (such as a global shutter, rolling shutter, shutter or any other type of shutter).

Using a strobe light may be particularly useful during periods of turbulence and other times the liquid is moving in the container.

Optionally, processing circuitry 2 selects respective optimal settings for the light source(s) based on a predefined algorithm. Optionally, the light source is controlled in accordance with the environment the system being monitored is currently operating in. For example, the light source may be turned on during nighttime operation and turned off during daylight.

Optionally, processing circuitry 2 changes the light source operation dynamically during operation. For example, by using different fibers of a fiber optic cable to emit the light at different times or by emitting light from two or more fibers at once.

Optionally, the light sources are part of monitoring system 1.

According to some embodiments, the one or more optical sensors may include one or more lenses and/or a fiber optic sensor. According to some embodiments, optical sensors 6.1-6.n may include a software correction matrix configured to generate an image from the optical sensor output signal. According to some embodiments, the one or more optical sensors may include a focus sensor configured to enable the optical sensor to adjust its focus based on changes in the obtained data. According to some embodiments, the focus sensor may be configured to enable the optical sensor to detect changes in one or more pixels of the obtained signals. Optionally, the changes in the focus may be used as further input data for processing circuitry 2.

### I. Indicators

The indicator may provide many types of information, relating to varied aspects such as the liquid volume, properties of the liquid, health evaluations, alerts, and maintenance-related information. Non-limiting examples of indicators are now presented.

Indicators providing information about the liquid volume and liquid motion may include but are not limited to:
1) The estimated liquid volume;
2) A rate of change of the liquid volume over time;
3) A prediction of a future liquid volume;
4) A frequency of liquid fluctuation in the container;
5) An amplitude of liquid fluctuation in the container; and
6) A difference between the estimated liquid volume and the expected volume; and
7) A difference between the estimated liquid volume and a liquid volume estimate received from other sources such as other sensors or the machine control.

Indicators providing information about properties of the liquid may include but are not limited to:
1) A color change of the liquid;
2) A change in the opacity of the liquid;
3) A change in the clarity of the liquid;
4) A change in viscosity of the liquid; and
5) The presence of particles in the liquid.

Health-related indicators may include but are not limited to:
1) An indicator of container health;
2) Health of a machine utilizing the liquid;
3) Health of a vehicle utilizing the liquid;
4) Health of a mechanism utilizing the liquid;
5) Health of a heating, ventilation, and air conditioning (HVAC) system;
6) Health of a peripheral component; and
7) Health of other sensors, such as other liquid measurement sensors.

Maintenance-related indicators may include but are not limited to:
1) Maintenance instructions;
2) A time to failure estimation;
3) A failure alert; and
4) Operating instructions in response to a detected failure.
   Selection of the indicator based on results of the analysis of liquid volumes is described in more detail below.

### II. The Container

Many types of containers for containing liquids are known. The container may have a regular geometrical shape (e.g. cube, rectangular cuboid, cylinder) or may have an irregular shape.

Optionally, the color of the liquid is optically distinguishable from the color of the container.

As used herein, according to some embodiments of the invention, the term “optically distinguishable” means that a difference between the liquid and the container may be detected in at least one channel of the optical sensor.

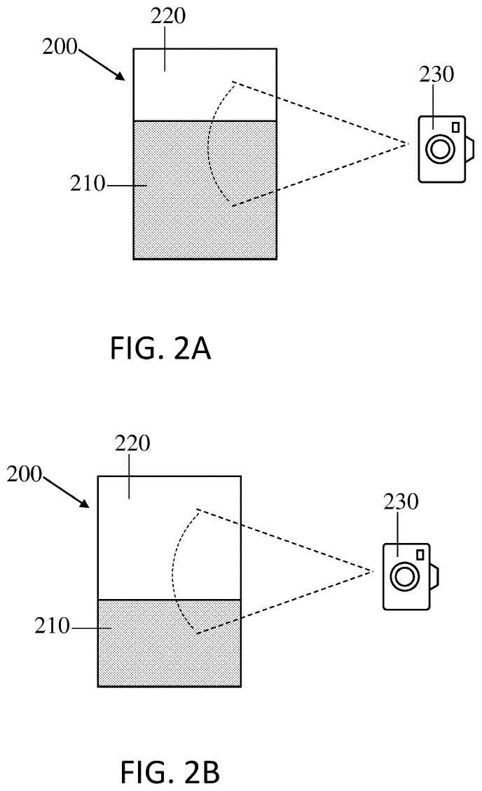

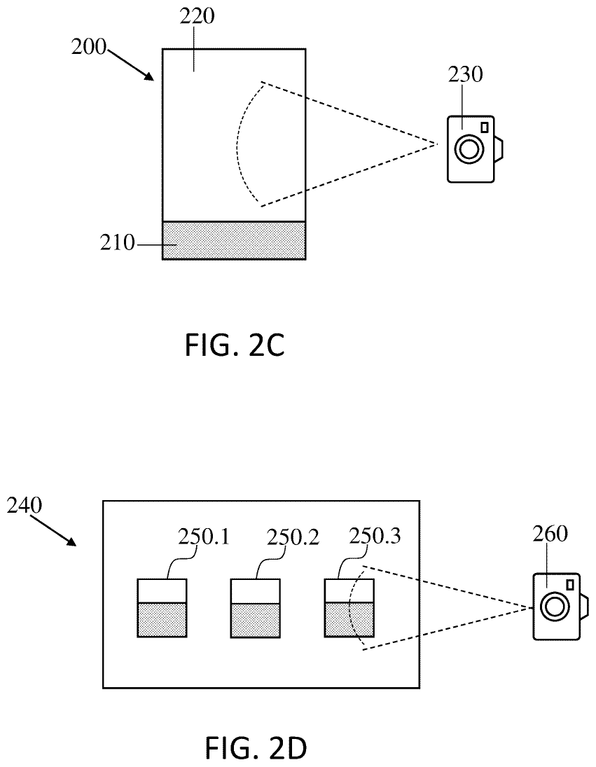

Optionally, at least one side of the container is transparent or semi-transparent so that the liquid may be seen through it, as illustrated in FIGS. 2A-2C. Optical sensor 230 has a field of view of a section of the side of 210. In one example, container 200 is a cylinder. In a second example, container 200 is a rectangular container.

The part of the container which is filled with liquid 210 is optically distinguishable from the part of the container without liquid 220. Images of the container captured by optical sensor 230 will differ based on the level of liquid in container 200.

Optionally, the container has one or more transparent or semi-transparent windows through which the liquid may be seen, as illustrated in FIG. 2D. Optical sensor 260 has a field of view which encompasses window 250.3.

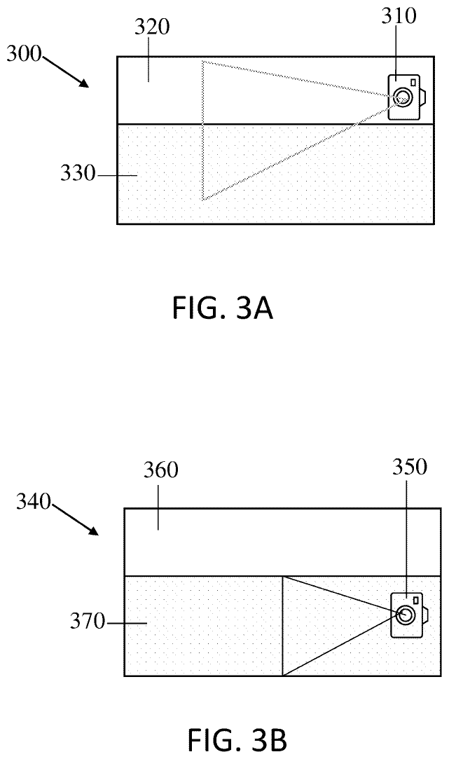

When the container does not have any transparent or semi-transparent sections the optical sensor(s) may be located inside the container, as described below with reference to FIGS. 3A-3B.

Non-limiting examples of containers for holding liquids include:
1) Bottles;
2) Tanks (e.g. fuel tanks for vehicles or machinery);
3) Drums;
4) Reservoirs (e.g. for hydraulic fluid or coolant);
5) Lubricant containers;
6) Coolant Expansion Tanks;
7) Transmission Fluid Pans;
8) Brake Fluid Reservoirs;
9) Radiator overflow Tanks.

Optionally, the container includes at least one liquid inlet and/or outlet. These locations may be particularly likely to develop leaks.

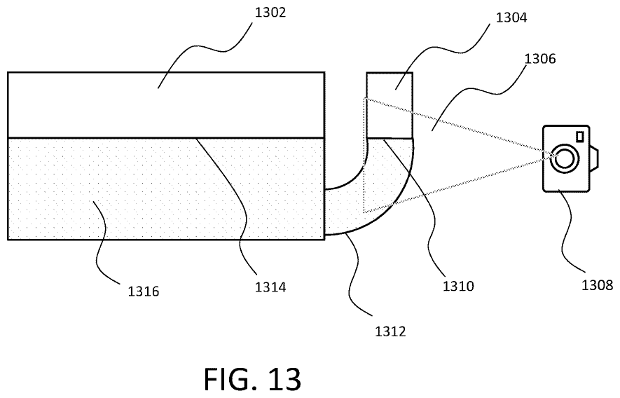

Optionally, the container includes a main vessel and a secondary vessel in fluid communication with each other. Optionally, at least one of the optical sensor(s) is positioned with a field of view of the secondary vessel. Since the two vessels are in fluid communication with each other, image(s) of the secondary vessel may be useful for determining the liquid volume in the entire container. An example is illustrated and described below with respect to FIG. 13.

### III. Image Collection

The images are obtained from one or more optical sensors which are positioned to have respective fields of view of at least a portion of the container through which the presence of the liquid may be detected. For example, the portion of the container may be transparent or partially transparent or may contain a transparent or partially transparent window through which the liquid may be seen.

Optionally, at least one optical sensor is located outside the container. Further optionally, the optical sensor is a non-contact sensor which is not in physical contact with the container. For example, the optical sensor may be mounted in a vehicle conveying the container or on a machine being fueled by liquid in the container.

Optionally, at least one optical sensor is located inside the container, as illustrated in FIGS. 3A-3B. In FIG. 3A, optical sensor 310 is located inside container 300 above liquid 330. In FIG. 3B, optical sensor 310 is located inside container 300 is submersed in liquid 330. In FIG. 3A the optical sensor's field of view includes both empty and liquid-filled portions of the container. However, this may not always be the case (for example when the container is completely full or completely empty). In FIG. 3B optical sensor 310 views the inside of the liquid and analysis of the image identifies where the liquid ends (i.e. the liquid surface) in order to measure the height and angle from the bottom of the tank

Optionally, at least one of the optical sensor(s) is mounted on an interior surface of the container.

Optionally, at least a portion of the interior surface of the container is a lens of the optical sensor.

### IV. Estimating the Liquid Volume

In some embodiments of the invention, an analysis of the input image(s) is performed in order to determine which pixels are liquid and which are not liquid.

In an exemplary embodiment, the decision about the type of pixel (i.e. liquid or non-liquid) is based on the distribution of pixel color values to differentiate between areas of the container images which show the liquid and areas of the container images that do not show the liquid. Pixels having a distribution consistent with the presence of the liquid are tagged as liquid. The distribution may be determined for multiple channels (e.g. RGB or RGB/IR) or, alternately, may be determined for a single channel (e.g. grayscale). Optionally, the probability that a given pixel matches the expected distribution for the liquid is performed using the Earth Mover Distance analysis. As will be appreciated by the skilled person, other analyses may be used.

Optionally, after the pixel type has been decided, pixels that are distant from the main volume of the liquid are eliminated and are not used to calculate the liquid volume. This is because it is expected that liquid pixels will be close together, thus distant pixels may be considered false positives (e.g. droplets on the container surface). In an exemplary embodiment, false positives are removed by a max-flow min-cut calculation, however other approaches may be used.

Optionally, once pixel type has been finalized, the liquid volume is calculated based on a geometrical analysis of the container shape.

In a simplified example which is based on a geometrical analysis of a single image, the height of the liquid level within the container may be used to identify what percentage of the container contains liquid. When the height of the liquid level is at the middle of the container, the container may be considered to be half full. Thus a ten liters container will be considered to contain five liters of liquid. When the height of the liquid level is a quarter of height of the container, the container may be considered to be a quarter full. Thus a ten liters container will be considered to contain two and a half liters of liquid.

Alternately or additionally, estimating the volume of the liquid from one or more images uses a model. For example, points of interest in the image (e.g. the intersection of the liquid surface with the face of the container) may be input into the model, which then outputs an estimated liquid volume.

According to some embodiments, the level of a liquid surface in a container may be indicated by markings on the container. Optionally, the markings may be features and/or markings selected from one or more images of the container. Optionally, the markings may be a point, line, scale, grid, intersection, sticker, vector and/or any other sign or symbol on the container. Optionally, the markings may be defects, natural lines, or border lines or deliberate markings on the container (e.g., a ruled line, a grid, a predetermined line or point, etc.). Optionally, the level of a liquid surface may be, for example, a point or line where the liquid in the container intersects with the perimeter of a container. Optionally, an algorithm/s applied to one or more images from one or more optical sensors may automatically identify and/or select the marking. Optionally, an operator may identify and/or select a marking, for example, through an application.

Optionally, the geometrical analysis includes determining the angle of the liquid surface relative to the container. Thus the volume of the liquid may be calculated even if the container is at an angle, or the container is in motion.

Optionally, the image(s) show a section of the container which is wide enough to estimate a three-dimensional angle of the liquid relative to the container.

In some embodiments concerning a rectangular container, the image or images should show at least two faces of the container in order to calculate the volume of liquid in a container that is tilted. The two faces may be in a single image of a corner of the container or in separate images captured by different optical sensors. Two edges may not be needed if the container is static, so the liquid surface does not tilt.

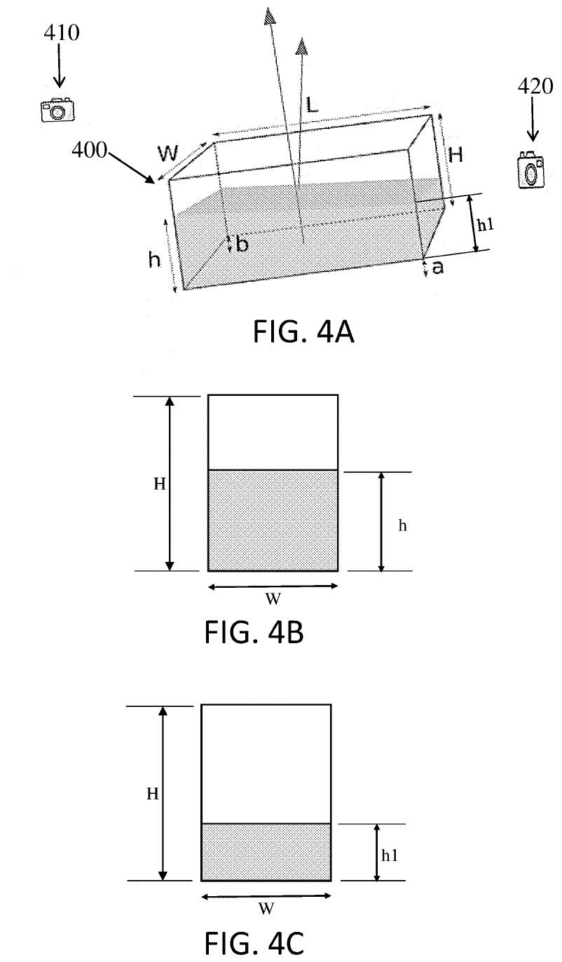

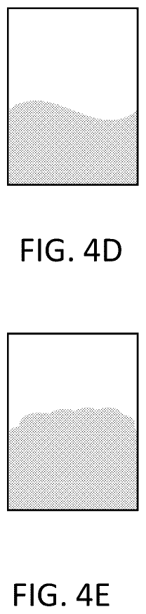

To illustrate, reference is now made to FIGS. 4A-4C which are simplified illustrations of a tilted rectangular container containing a liquid and images of two faces of the container. FIG. 4A is an isometric illustration of the container 400 which is tilted. Because of the tilt, the surface of the liquid is horizontal relative to the ground but is at an angle relative to the container faces. Optical sensors 410 and 420 capture images of opposite faces of container 400.

FIGS. 4B and 4C are simplified illustrations of images captured by image sensors 410 and 420 respectively.

The height of the liquid in the image captured by image sensor 410 is h, whereas the height of the liquid on the face opposite image sensor 420 is h1. Heights h and h1 may be used to calculate the tilt of the liquid surface relative to container 400 by a geometrical analysis.

Optionally, variations in the relative heights of reference points (e.g. h relative to h1) are used to estimate variations in the volume of liquid in the container. For example, the rate of change of the liquid volume may be calculated from the time period it takes for the height of the liquid in the container to change from h to h1. Optionally, variations in the heights of the liquid at different sections of the container are used to evaluate the health of the container and/or associated elements.

According to some embodiments, the container has an irregular shape whose volume which is difficult to represent geometrically. Estimating the volume of the liquid from images of an irregularly shaped container may be complex. Optionally, additional information is used to estimate the liquid volume from the image(s), such as using a three-dimensional model, simulation results, a machine-learning trained model, etc. for estimating the liquid volume in complex cases or in order to provide a more accurate estimation.

FIGS. 4A-4C illustrate a case in which the liquid surface is flat. In other conditions the liquid surface may be wavy, turbulent or another shape which is not flat.

Reference is now made to FIGS. 4D-4E which are simplified illustrations of an image of the face of a container containing wavy and turbulent liquids respectively. The waves and turbulence may be caused by many factors, such as linear motion, an object hitting the container and other forces. These forces may not cause the container to tile, but may nonetheless cause changes in the surface of the liquid.

Optionally, the image(s) are captured while the container is in motion relative to the ground (e.g. linear, rotational, vibrational, etc.). When the relative position of at least one optical sensor is static relative to the container (i.e. the container and optical sensor move together), movement of the container relative to the ground may not be reflected in a single image. However, the motion may be noticeable in motion of the liquid in the container (e.g. waves and turbulence). An abrupt movement of the container may cause rapid and irregular motion in the liquid, which may be perceptible in images captured by the optical sensor. Using a strobe light may be beneficial for imaging the liquid during periods of rapid and irregular motion.

Optionally, determination of the liquid volume is based on an analysis of multiple images. Aggregating data from multiple images may stabilize the results when the liquid is moving within the container. Further optionally, the liquid volume is estimated based on a statistical analysis of a sequence of images. In a simplified example, the liquid volume is estimated by averaging the results obtained over time. In another example, the contour of the liquid surface is identified in the image (and/or may be added as a line on the image). The contour is used to derive a shape of the liquid in the container from which the volume may be calculated.

The results of the image analysis may be correlated with information from one or more other sensors or external sources. Non-limiting examples include:
1) Motion sensor (e.g. accelerometer, gyroscope, magnetometer, magnetic compass, vibration or tilt sensor);
2) Temperature sensor;
3) Non-optical liquid level sensor (e.g. liquid level floats);
3) Navigation system information (e.g., GPS); and
4) Control system information (e.g. flight control information).

For example, a motion sensor may give information about times that the container is moving and images from those times may not be used to estimate the liquid volume.

In one example, the container is mounted in an aircraft and flight control data is used in the image analysis to estimate the liquid volume. Further optionally, the flight control data may provide the speed, height and direction of the aircraft (including turning direction) and the angle of deviation of the aircraft. This information is used to calculate the aircraft acceleration component (in 3D) and the gravity induced acceleration (based on height measurement) and the resulting forces acting on the liquid. From those calculations, the liquid's orientation in three dimensions may be approximated. In this case the use of two optical sensors or capturing two edges of the container in a single image may be redundant. Thus, in such case images of only one side of the container may be sufficient for estimation of liquid volume.

Optionally, estimating the liquid volume takes into account known properties of the liquid. For example, a viscous liquid may react more slowly to container motion or other forces than a less viscous liquid.

### V. Selecting and Outputting an Indicator

After the liquid volume is estimated (for a single time point or at multiple time points) an indicator is selected and output. The indicator provides information about whether the liquid volume(s) estimated by analysis of the image(s) are consistent with the expected liquid volume. In some embodiments, the analysis may also indicate other properties of the imaged liquid which may be an indication of other failure modes of the machine or components thereof. For example, the output may indicate the amount of bubbles in the liquid, the viscosity or color of the liquid and the like.

As used herein, according to some embodiments of the invention, the term “consistent with the expected liquid volume” and similar terms mean that parameters obtained by analysis of one or more estimated liquid volumes behave in accordance with the expected behavior of the same parameter under normal conditions. The term “consistent with expected liquid volume” is not limited to an evaluation of the current liquid volume, but, alternately or additionally, may be evaluated based on derived parameters such as the rate of change of the liquid volume, indications from other sensors and/or trends extracted from a progression of the liquid volume values.

As used herein, according to some embodiments of the invention, the term “rate of change of the expected liquid volume” and similar terms mean the difference between the quantity and direction of the change in liquid volume at different time periods.

Note that both the change in liquid volume and the rate of change in liquid volume may be in a positive or negative direction (e.g. when fluid is added to the container or when liquid from the container is consumed).

The expected liquid volume may be calculated by any means known in the art. For example, the expected liquid volume may be the volume of liquid initially held by the container minus the volume expected to be consumed and/or lost (due to evaporation, evaporation, adsorption, etc.) under normal conditions since the container was filled.

Parameters and data used to estimate this consistency may include but are not limited to:
1) The estimated liquid volume;
2) The rate of change of the liquid volume over time;
3) A prediction of a future liquid volume;
4) A prediction of a variation in the rate of change of the liquid volume over time (e.g. increase or decrease).
5) Data obtained from other sensors, such as other volume measurement sensors or sensors indicating the amount of liquid expected to be consumed.
6) Data provided by the element associated with the container.
7) Data provided by external systems (e.g. flight control systems).

The predictions may be made based on a trend analysis of changes in the liquid volume over time.

In one example, the estimated liquid volume is within an expected range, however the liquid volume is diminishing or increasing faster than expected. In this case the analysis may find that the liquid volume is inconsistent with the expected liquid volume, even though the current liquid volume may be acceptable for system performance.

The time(s) at which the analysis is performed may be tailored to the needs of a particular system, machine, aircraft, etc. Examples of when the analysis and indicator output may be performed include but are not limited to:
1) Ongoing;
2) Periodically.
3) Only during operation;
4) Both during operation and during idle time periods (as leakage may not necessarily be related to operation).
5) When an indication of a problem is received, for example from other sensors in the system.
   Optionally the analysis is performed more frequently when certain conditions appear (e.g. certain flight conditions or when indication from other sensors indicate problem).

Optionally, the indicator is retrieved from a data structure indexed by one or more of the above parameters and/or data, as described below with reference to Tables 1-2.

Alternately or additionally, the consistency analysis and/or selecting the indicator to be output is based on a model. The model may be developed by any means known in the art. Further optionally, the model is based on machine learning as described below.

Alternately or additionally, selection of the indicator to be output is based on a model developed by any means known in the art. Further optionally, the model is based on machine learning as described below.

Optionally, the indicators are used by a control system and/or preventive maintenance system, which decide whether further actions should be taken (for example decisions about the operation and/or maintenance of the element associated with the liquid container).

Reference is now made to Tables 1 and 2, which are simplified examples of data structures that may be used to select an indicator for output. In both cases the indicator is related to failure detection and preventive maintenance.

In Table 1 the indicator is selected based on two parameters relating to liquid volume, whose values are estimated by analysis of images of the container. Standard maintenance is indicated when the liquid volume and/or rate of decrease of liquid volume are within expected ranges.

TABLE 1

| | Liquid volume | | |
|---|---|---|---|
| Rate of decrease | <10 liters | 10-50 liters | >50 liters |
| <200 ml. per hour | Early | Standard | Postpone |
| | maintenance | maintenance | maintenance |
| | required | | |
| 200 ml.-1 liter per hour | Standard | Standard | Standard |
| | maintenance | maintenance | maintenance |
| >1 liter per hour | Failure alert | Early | Standard |
| | | maintenance | maintenance |
| | | required | |

Optionally, maintenance instruction may relate to a leakage, for example the presence of fuel in the container surroundings which may cause other problems and therefore a failure alert may be provided even when container is relatively full. In a second example, the container is not of critical importance to system so a failure alert will not be provided (e.g. the health of the air conditioning system in a vehicle may not critical for vehicle performance, even if the air conditioning is not working).

In Table 2 the indicator is selected based on one parameter value related to the liquid volume and on data from a temperature sensor. For example, if the container contains fuel for a machine, the temperature may correlate to the load the machine is operating under. Therefore fuel consumption may be expected to be higher when the temperature is higher relative to fuel consumption at a lower temperature. The rate of fuel consumption determined by the analysis is compared to the expected rate of fuel consumption at the given temperature. The indicator indicates whether the rate of change of the liquid volume (e.g. fuel consumption) is lower than acceptable, within an expected range or higher than expected.

TABLE 2

| | | Rate of decrease | | |
|---|---|---|---|---|
| Temperature | | <10 liters/hour | 10-50 liters/hour | >50 liters/hour |
| <50° | C. | Expected fuel | High fuel | Alert - excessive |
| | | consumption | consumption | fuel consumption |
| 50-100° | C. | Low fuel | Expected fuel | High fuel |
| | | consumption | consumption | consumption |
| >100° | C. | Alert - | Low fuel | Expected fuel |
| | | insufficient | consumption | consumption |
| | | fuel | | |
| | | consumption | | |

Further actions may be taken in response to the output indicator. For example, in Table 2 both alerts may alert the operator to turn off the machine to prevent failure. When the indicator shows expected fuel consumption over time, the regular maintenance schedule may be followed. Depending on the particular situation, low fuel consumption may be considered a problem which requires early maintenance or a benefit which extends the time until the next maintenance is required.

### VI. Monitoring Other Components

Optionally, the monitoring system also inputs images of other components in the machine/vehicle/aircraft/etc. and performs additional evaluation, optionally as described in PCT Publ. WO2022162663 which is incorporated herein by reference. The images may be provided by the optical sensors imaging the container and/or other optical sensors. The additional analysis may identify defects or faults not necessarily related directly to the container and liquid volume, such as corrosion, cracks, structural damage, etc.

Optionally, the results of the additional evaluation are correlated with the results of the liquid volume estimation and analysis in order to select the indicator. For example, liquid accumulation in an unexpected location may explain why the liquid volume is dropping. Thus maintenance instructions may be focused on specific modes of failure which relate to the accumulation of the liquid at that location.

### VII. Machine Learning

In some embodiments, the model used for estimating liquid volume level and/or selecting the indicator to be output is a machine learning model trained with a training set by supervised learning algorithm or by a non-supervised learning algorithm. Optionally, the model is a neural network.

Optionally, the training set includes one or more of:
1) Images collected during periods of usage of the liquid;
2) Images collected during periods of non-usage of the liquid;
3) Images collected of a similar container or a different container in a similar machine during periods of usage; and
4) Images collected of a similar container or a different container in a similar machine during periods of non-usage.
5) Image(s) of other components, possibly provided by other optical sensors.
6) Non-image data associated with some or all of the images in the training set.

For example the non-image data may include environmental and operational conditions when the image was captured. In a further example, the training set includes flight control information which may be correlated to the times the images were captured.

Optionally, the images in the training set refer to image analysis and not necessarily to the image data itself (e.g. for any or all of items 1-5 above); the results of the image analysis are input and not the images themselves.

Optionally, the model is trained prior to actual use of the container or of the monitoring system (e.g. during a preliminary training period).

Optionally, the model is periodically retrained based on image(s) and or other data collected over time.

### VIII. Method for Monitoring a Liquid Volume

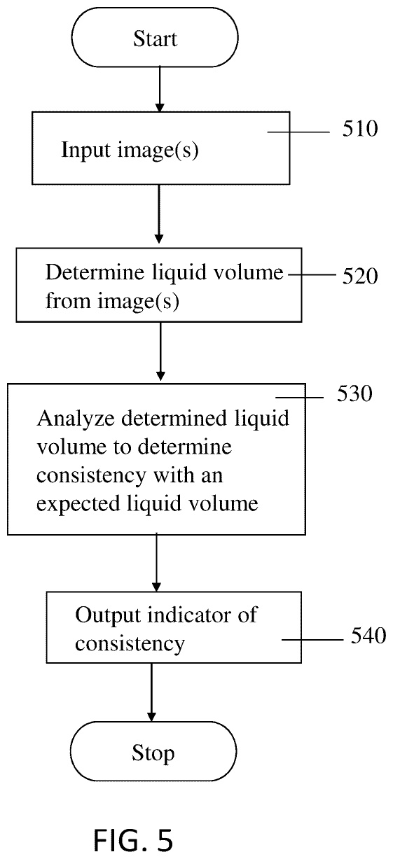

Reference is now made to FIG. 5, which is a simplified flowchart of method for monitoring a liquid volume, according to embodiments of the invention.

In 510 at least one image of a liquid contained in a container is input from at least one optical sensor.

In 520 the liquid volume in the container is estimated from the image(s). Optionally, the volume of the liquid is estimated according to the embodiments described above.

In 530 the estimated liquid volume(s) values are analyzed to evaluate whether they are consistent with the expected liquid volume. Optionally, the consistency is evaluated according the embodiments described above.

In 540, an indicator is output. The indicator is selected based on the results of the analysis in 530. The indicator may be a binary output (e.g. consistent/not consistent) and/or may include additional information, such as the estimated volume or properties of the imaged liquid.

Optionally, the image(s) are provided by a single optical sensor. The single optical sensor may image one, two or more sides of a polygonal container. Alternately the images are provided by multiple optical sensors capturing images of the container with respective fields of view.

Estimating the liquid volume from multiple images may improve the accuracy of the result but may require greater computational resources.

Optionally, the indicator includes an assessment of a health of at least one of:
the container:
a machine utilizing the liquid;
a vehicle or aircraft utilizing the liquid;
a mechanism utilizing the liquid;
a heating, ventilation, and air conditioning (HVAC) system; and
a peripheral component.

Optionally, the indicator includes at least one of:
the estimated liquid volume;
a rate of change of the liquid volume over time;
a prediction of a future liquid volume;
at least one of a frequency and an amplitude of a liquid fluctuation in the container;
a color change of the liquid;
a change in opacity of the liquid;
a change in clarity of the liquid;
a change in viscosity of the liquid;
a presence of particles in the liquid;
maintenance instructions;
a time to failure estimation;
a failure alert; and
operating instructions in response to a detected failure.

In an exemplary embodiment, estimating the liquid volume includes analyzing a distribution of intensities in at least one channel of the at least one image and identifying pixels having a distribution consistent with a presence of a liquid.

Optionally, estimating the liquid volume includes eliminating pixels distant from a main volume of the liquid from a calculation of the liquid volume.

Optionally, estimating the liquid volume includes calculating the liquid volume based on a geometrical analysis of a container shape.

Optionally, estimating the liquid volume is based on a statistical analysis of a sequence of images.

Optionally, estimating the liquid volume is further based on data obtained from non-optical sensors.

Optionally, estimating the liquid volume is further based on data obtained from external sources.

Optionally, analyzing the consistency of the estimated liquid volume(s) to an expected liquid volume is based on one or more of:
a current liquid volume;
a change of the liquid volume over time.
a trend analysis of changes in the liquid volume over time.

Optionally, at least one image shows two sides of the container.

Optionally, at least one image shows a section of the container, the section being wide enough to estimate a three-dimensional angle of the liquid relative to the container.

Optionally, the image is captured while the container is in motion relative to the ground.

Optionally, at least one optical sensor is located outside the container.

Optionally, at least one optical sensor is located inside the container.

Optionally, the method further includes retrieving the indicator from a data structure using the values of one or more of:
the estimated liquid volume;
a rate of change of the liquid volume over time;
a prediction of a future liquid volume; and
a prediction of a variation in the rate of change of the liquid volume over time.

Optionally, the analysis is based on a machine learning model trained with a training set, where the training set includes one or more of:
images collected during periods of usage of the liquid;
images collected during periods of non-usage of the liquid;
images collected of a similar container during periods of usage; and
images collected of a similar container during periods of non-usage.

Optionally, the machine learning model is a neural network.

Optionally, the machine learning model is trained using a supervised learning algorithm.

Optionally, the machine learning model is trained using an unsupervised learning algorithm.

Optionally, the training set includes non-image data associated with at least some of the images in the training set.

### IX. Exemplary Embodiment

According to some embodiments, there is provided an exemplary system for monitoring a volume of liquid and/or a change in a volume of liquid and/or a rate of change of a volume of liquid in a container and/or a change in a property of a liquid in the container. The monitoring system includes an optical sensor. According to some embodiments, the system for monitoring a volume of liquid and/or a change in a volume of liquid and/or a rate for change of a volume of liquid and/or a change in a property of a liquid in a container may include a processor in communication with one or more optical sensors configured to observe the level of a liquid in a container.

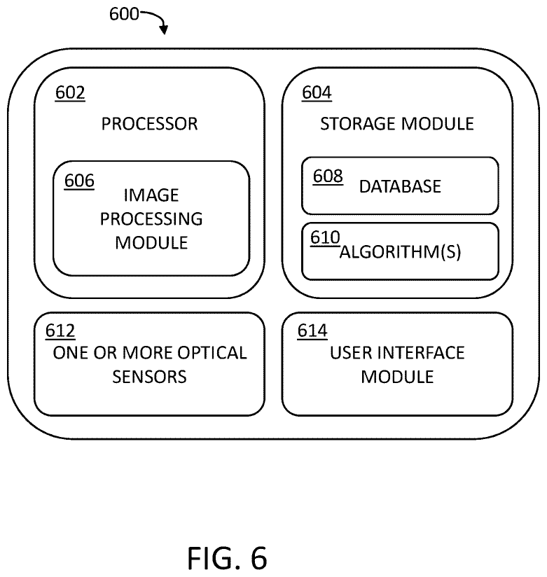

According to some embodiments, the optical sensor and/or processor and/or other circuitry of FIGS. 6-13 may be according to embodiments of the optical sensors, processing circuitry and/or other circuitry (e.g. illumination source) as described with respect to FIGS. 1-5.

Optionally, the container is under motion. Optionally, motion is linear, rotational, or both.

According to some embodiments, the container is located in a vehicle. Optionally, the vehicle is a motor vehicle (e.g., a car, truck, construction vehicle, motorcycle, electric scooter, electric bicycle, etc.), aircraft (e.g., airplane, space craft, helicopter, drone, etc.), watercraft (e.g., ship, boat, submarine, hovercraft, underwater drone, etc.). According to alternate optional embodiments, the container is located in a machine (e.g., multi axis machining center, cranes, robots used in production lines, robots used in extreme environmental conditions, etc.) or mechanism (e.g., manipulators, grippers, hydraulic pistons, etc.).

According to some embodiments, the optical sensor(s) are located so as to provide one or more images of one or more sides of a container. Optionally, the one or more images are still images, a portion of an image, a set of images, one or more video frames or any combination thereof. Optionally, the monitoring system may include one or more additional sensors. Optionally, in a moving system the one or more additional sensors may include an accelerometer. Optionally, the optical sensor(s) may acquire one or more images while the vehicle is at a constant velocity and/or moving in a straight and/or level direction. Alternatively, the optical sensor(s) may continuously acquire images, also when the vehicle is in motion.

According to some embodiments, the container is partly filled with a liquid optically distinguishable from the container, such as by its color, viscosity, or the color of the container (e.g., colored liquid, oil, mercury, a syrup, etc.). Optionally, the container is partially or completely transparent, semi-transparent, opaque, or translucent. Optionally, the container is a different color than the liquid contained therein. Optionally, the container is partially or completely transparent to an optical sensor.

According to some embodiments, at least one optical sensor is located outside the container. Optionally, at least one of the optical sensor(s) is positioned such that its field of view encompasses at least one wall or a section of a wall of the container.

Optionally, when at least one optical sensor is located outside the container (also denoted herein an external optical sensor), at least a part of the container is at least partially transparent to the external optical sensor(s). Optionally, the container includes at least one window through which the liquid may be imaged. Optionally, external optical sensor(s) are positioned such that their field of view encompasses some or all of at least one window.

According to some embodiments, the container includes a main vessel and a secondary vessel in fluid communication with each other, as shown in FIG. 13. Optionally, at least one of the optical sensor(s) is positioned with a field of view of the secondary vessel.

Optionally, the monitoring system includes one or more illumination sources. Further optionally, the one or more illumination sources may be configured to illuminate the container, window, secondary vessel, or part thereof.

According to some embodiments, at least one optical sensor (also denoted herein an internal sensor) is located inside the container. Optionally, at least one internal optical sensor is completely or partially immersed in the liquid. Optionally, at least one internal optical sensor may be positioned such that its field of view encompasses the liquid surface and at least one wall of the container, thereby permitting an analysis of the liquid level within the container.

Optionally, the monitoring system includes one or more illumination sources. Optionally, the one or more illumination sources may be respectively configured to illuminate the container and/or the liquid and/or the liquid surface and/or a part thereof.

According to some embodiments, the optical sensor(s) an electro-optical sensor. According to some embodiments, the optical sensor(s) include a camera. According to some embodiments, the optical sensor(s) include any one or more of a charge-coupled device (CCD) and a complementary metal-oxide-semiconductor (CMOS) sensor (or an active-pixel sensor), or any combination thereof. According to some embodiments, the optical sensor(s) include any one or more of a point sensor, a distributed sensor, an extrinsic sensor, an intrinsic sensor, a through beam sensor, a diffuse reflective sensor, a retro-reflective sensor, or any combination thereof. According to some embodiments, the optical sensor(s) include one or more lenses. According to some embodiments, the optical sensor(s) include a fiber optic sensor.

Optionally, the sensors operate in IR and/or visible and/or UV frequencies.

According to some embodiments, the one or more illumination sources include any one or more of a light bulb, light-emitting diode (LED), laser, a fiber illumination source, fiber optic cable, and the like.

According to some embodiments, at least one processor is used to analyze the one or more images from the optical sensor(s), for example to determine the liquid surface level and/or liquid surface plane and/or liquid surface plane vector.

Optionally, the processor is located remotely, for example in a control room monitoring machines in a factory.

Optionally, the at least one processor is in communication with the optical sensor(s). Optionally, the processor may be connected to optical sensor(s) wirelessly (e.g., Bluetooth, cellular network, satellite network, local area network, etc.) and/or by wired communication (e.g., telephone networks, cable television or internet access, and fiber-optic communication, etc.).

According to some embodiments, the at least one processor may receive a signal from the optical sensor(s). Optionally, the received signal may comprise one or more images of at least part of the surface of the liquid and/or at least a surrounding section of a perimeter of the container.

According to some embodiments, the volume of liquid and/or a change in a volume of liquid in a container is estimated from one or more images from optical sensor(s). Optionally, the optical sensor(s) is configured to monitor the liquid surface in a container. According to some embodiments, the volume of liquid and/or a change in a volume of liquid in a container may be calculated from the level of the liquid surface in the container and one or more known parameters characterizing the container. Optionally, the known parameters characterizing the container may include container dimensions (e.g., container shape, total container volume, height, length, width, area, circumference, perimeter, weight, acceleration, pitch and roll angles, etc.), scale markings (e.g., metric or Imperial), or both.

According to some embodiments, volume of liquid and/or a change in a volume of liquid in a container may be estimated from one or more images from optical sensor(s). Optionally, the optical sensor(s) is configured to monitor the liquid surface in a container. Optionally, from the one or more images at least three different dimensions may be extracted, for example, from the intersection of the liquid surface with the perimeter of the container. Optionally, based on the points the liquid surface plane direction (direction of the vector normal to the plane) may be calculated. According to some embodiments, the selected dimensions may be estimated using the optical sensor(s) (e.g., cameras) of the monitoring system.

According to some embodiments, the liquid plane relative to a horizontal plane of the container, and optionally one or more known parameters characterizing the container, angle and/or acceleration effects may be eliminated. Optionally, the known parameters characterizing the container include one or more container dimension (e.g., container shape, total container volume, height, length, width, area, circumference, perimeter, weight, acceleration, pitch and roll angles, etc.), scale markings (e.g., metric or Imperial), or both. Optionally, the volume of liquid and/or a change in a volume of liquid in a container may be thereby estimated. According to some embodiments, the selected dimensions and/or volume of liquid and/or a change in a volume of liquid in a container may be estimated by analyzing multiple images/video clips of a system, such as a machine and/or structure, and determining respective permitted ranges/margins of each selected point and/or an orientation that may still be defined as permitted.

According to some embodiments, the volume of liquid and/or a change in a volume of liquid in a container may be calculated by taking into account the difference between the vector normal to the liquid surface plane and a vector normal to a horizontal plane of the container. Optionally, the vector \vec{n} of the plane of the liquid surface may be calculated.

According to some embodiments, the vector of the plane of the liquid surface may be expressed as:

$$\vec{n} = \vec{g} + \vec{a}$$

Alternatively, and/or additionally, from this expression in combination with the known or measured acceleration vector \vec{a} the roll and pitch of the system's tilt may be calculated by subtracting vector \vec{a} from vector \vec{n}. In stationary systems, \vec{a}=0.

According to some embodiments, the volume of liquid in a container may be monitored over a period of time (e.g., seconds, minutes, hours, days, the duration of a journey, distance traveled, number of operating hours, cycle time, etc.) and the rate of change of the volume of liquid calculated. Optionally, the rate of change of the volume may be compared to previously calculated, previously defined and/or previously measured rate of change of the volume of liquid in the container. Optionally, the rate of change of the volume of a liquid may be compared to a curve of the liquid volume over time. Optionally, calculation of the rate of change of the volume of a liquid may be plotted. Optionally, calculation of the rate of change of the volume of a liquid may take into account acceleration and/or deceleration of the vehicle and/or function of the vehicle. Optionally, the rate of change of the volume of a liquid in a container may be an average, weighted average, mean, etc. for the defined period of time.

According to some embodiments, the monitoring system may comprise one or more motion related sensors. Further optionally, the one or more motion related sensors include one or more of an accelerometer, navigation system (e.g., GPS), gyroscope, magnetometer, magnetic compass, hall sensor, or tilt sensor inclinometer spirit level. Optionally, the monitoring system may also function as an accelerometer, for example if the orientation is zero or known (e.g., from an inclinometer, gyroscope, etc.). Optionally, a plane angle may be determined using data from a motion detector (e.g., an accelerometer). Optionally, the volume of liquid in a container may be calculated using a single optical sensor observing the container without the need to identify and calculate the relative plane between the liquid and the container using data from both an inclinometer and motion detector (e.g., an accelerometer).

According to some embodiments, analyzing whether the volume of liquid and/or a change in a volume of liquid and/or rate of change of a volume of liquid in a container fall within a predefined deviation from one or more predefined and/or predetermined values. Optionally, at least one inconsistency in the volume of a liquid and/or rate of change of a volume of a liquid may be identified. Optionally, data associated with a characteristic of a fault in the container and/or associated component, unexpected use, unauthorized use, etc. may be obtained from a database. Optionally, the at least one identified inconsistency may be applied to an algorithm. Optionally, the algorithm may be configured to analyze the identified inconsistency of one or more images received from optical sensor(s). Optionally, the algorithm may be configured to classify whether the identified inconsistency in the one or more images received from optical sensor(s) is associated with a fault in the container based, at least in part, on the obtained data. Optionally, a signal indicative of the identified inconsistency associated with a fault for an identified inconsistency classified as being associated with the fault may be output (e.g., the signal may indicate that maintenance may be required based on the associated fault).

According to some embodiments, the monitoring may further comprise identifying a change in the volume of liquid and/or a change in a volume of liquid in a container and/or a rate of change in the volume of a liquid in a container, which may be calculated based on a change from a baseline angle measurement, pre-determined and/or pre-calculated and/or pre-defined value. According to some embodiments, the monitoring may further comprise identifying a volume of liquid and/or a change in a volume of liquid and/or a rate for change of a volume of liquid in a container, may be calculated based on a change in the deviation of a volume of liquid and/or a change in a volume of liquid and/or a rate for change of a volume of liquid in a container from a pre-determined and/or pre-calculated and/or pre-defined value.

According to some embodiments, the monitoring may further include alerting a user of a suspected and/or predicted malfunction/failure/damage/fault of the container.

According to some embodiments, the modes of failure may be determined by analyzing multiple images/video clips/data obtained from containers and/or associated components and obtaining a volume of liquid and/or a change in a volume of liquid and/or a rate for change of a volume of liquid in a container that are typical to failure. As an example of a failure, a large reduction in a volume of oil and/or a high rate of reduction of a volume of oil in a container may be indicative of high oil consumption of an engine, which may indicate an oil burning problem, which may result, for example, from mal functioning valve seals, and/or malfunctioning piston ring. As another example of a failure, high coolant consumption may indicate an overheated machine, leakage of the cooling system, a damaged radiator, an open radiator cap, etc. As another example, low lubricant or coolant consumption of a machine such as a multi axis machining center may indicate blocked tubing and/or nozzles, etc.

According to alternative or additional embodiments, the failure may result from failed containers, primary and/or secondary vessels, pipes, hoses, loose screws, cracked lids and/or covers, etc., or components thereof, which may, for example, also be detected by analyzing multiple images/video clips/data obtained from containers and/or associated components.

According to some embodiments, a rate of deviation of the volume of liquid and/or a change in a volume of liquid and/or a rate for change of a volume of liquid in a container from their respective expected volume of liquid and/or a change in a volume of liquid and/or a rate for change of a volume of liquid in a container may be determined and/or utilized to predict a timeline to failure.

According to some embodiments, the level of a liquid surface in a container may be indicated by markings on the container. Optionally, the markings may be features and/or markings selected from one or more images of the container. Optionally, the markings may be a point, line, scale, grid, intersection, sticker, vector and/or any other sign or symbol on the container. Optionally, the markings may be defects, natural lines, or border lines or deliberate markings on the container (e.g., a ruled line, a grid, a predetermined line or point, etc.). Optionally, the level of a liquid surface may be, for example, a point or line where the liquid in the container intersects with the perimeter of a container. Optionally, an algorithm/s applied to one or more images from one or more optical sensors may automatically identify and/or select the marking. Optionally, an operator may identify and/or select a marking, for example, through an application. Optionally, changes in the volume of liquid and/or a change in a volume of liquid and/or a rate for change of a volume of liquid in a container may be indicative of compromised structural integrity of the container and/or associated components. Optionally, an associated component may be a primary or secondary vessel, pipe, hose, cover, screw, etc.

Additionally, and/or alternatively, the monitoring system and/or method may further be configured to provide an indication of the integrity of the container and/or associated components. Optionally, the volume of liquid and/or a change in a volume of liquid and/or a rate for change of a volume of liquid in a container in a container may provide an indication of the integrity of the container and/or associated components and/or may provide the basis for predicting the time to failure of a container and/or associated components. Optionally, the volume of liquid and/or a change in a volume of liquid and/or a rate for change of a volume of liquid in a container may provide an indication that maintenance may be required.

According to some embodiments, the processor may be executable to:
receive signals from the at least one optical sensor observing a liquid surface in a container so as to obtain data associated with characteristics of at least one mode of failure of the container and/or associated component,
identify at least one change in the received signals, for an identified change in the received signals (for example, a variation in the liquid surface level or volume of liquid and/or a change in a volume of liquid and/or a rate for change of a volume of liquid in a container calculated at least in part therefrom, from a pre-obtained or pre-calculated the value for a liquid surface level, volume of liquid and/or a change in a volume of liquid and/or a rate for change of a volume of liquid in a container),
optionally, to apply the at least one identified change to an algorithm configured to analyze the identified change in the received signals and to classify whether the identified change in the received signals is associated with a mode of failure of the container and/or associated component, thereby labeling the identified change as a trend, based, at least in part, on the obtained data and for an identified change is classified as being associated with a mode of failure,
outputting a signal indicative of the identified change associated with the mode of failure.

According to some embodiments, for an identified fault, the processor may generate at least one model of a trend in the identified fault, wherein the trend may include a rate of change in the fault.

According to some embodiments, the monitoring system may be configured for smart maintenance of the container and/or associated component, by using one or more algorithms configured to detect a change, identify a fault, and determine whether the fault may develop into a failure of the structure.

According to some embodiments, for an identified trend, the processor may generate at least one model of a trend, wherein the trend may include a rate of change.

According to some embodiments, the monitoring system may be configured for smart maintenance of the container and/or associated component, by using one or more algorithms configured to detect a change, thereby identify a trend, and determine whether the trend may develop into a failure of the structure.

Advantageously, the monitoring system and/or method may enable volume measurement in inaccessible areas which may require high efforts to be examined/maintained, by positioning the optical sensor(s) within or in sight of a container that may not be monitored otherwise.

Advantageously, the monitoring system may enable trend identification and calculation, thereby analyzing the trends in the volume of liquid and/or a change in a volume of liquid and/or a rate for change of a volume of liquid in a container, and thus enabling the prediction of failure even before there is a change in normal behavior or operation of the container and/or associated component. According to some embodiments there is provided a system for monitoring potential failure in a container and/or associated component, the monitoring system including: a container containing a liquid optically distinguishable from the container and at least one optical sensor, configured to be mounted within or with a field of view of the container, at least one processor in communication with the optical sensor, the processor being executable to: receive signals from the at least one optical sensor observing the container, obtain data associated with characteristics of at least one mode of failure of the container and/or associated component, identification of at least one change in the received signals, for an identified change in the received signals, apply the at least one identified change to an algorithm configured to analyze the identified change in the received signals and to classify whether the identified change in the received signals is associated with a mode of failure of the container and/or associated component, thereby labeling the identified change as a fault, based, at least in part, on the obtained data, and for an identified change is classified as being associated with a mode of failure, outputting a signal indicative of the identified change associated with the mode of failure.

According to some embodiments there is provided a computer implemented method for monitoring a container, the method including: receiving signals from at least one optical sensor observing the level of a liquid surface in a container, wherein the liquid may be optically distinguishable from the container, configured to be mounted within or with a field of view of the container, obtaining data associated with characteristics of at least one mode of failure of the container and/or associated component, identifying at least one change in the received signals, for an identified change in the received signals, applying the at least one identified change to an algorithm configured to analyze the identified change in the received signals and to classifying whether the identified change in the received signals is associated with a mode of failure of the container and/or associated component based, at least in part, on the obtained data, and for an identified change classified as being associated with a mode of failure, outputting a signal indicative of the identified change associated with the mode of failure.

According to some embodiments, for an identified trend, the method and/or monitoring system may include generating at least one model of the trend.

According to some embodiments, the trend may include a rate of change of liquid surface level and/or volume.

According to some embodiments, generating the at least one model of trend may include calculating a correlation of the rate of change of liquid surface level and/or volume with one or more environmental parameters.

According to some embodiments, for an identified trend, the method and/or monitoring system may include alerting a user of a predicted failure based, at least in part, on the generated model.

According to some embodiments, alerting the user of a predicted failure may include any one or more of a time (or range of times) of a predicted failure, a usage time of the container and/or associated component and characteristics of the mode of failure, or any combination thereof.

According to some embodiments, identifying at least one change in the received signals includes identifying a change in the rate of change in the received signals.

According to some embodiments, a processor and/or algorithm may take into account one or more environmental parameters including at least one of temperature, season or time of the year, pressure, time of day, hours of operation of the container and/or vehicle, duration of operation of the container and/or vehicle (e.g., age of the container and/or vehicle, cycle time, run time, down time, etc.), an identified user of the structure, GPS location, mode of operation of the container and/or associated component (e.g., continuous, periodic, etc.), and/or any combination thereof. Optionally, the monitoring system may retrieve data on one or more environmental parameters from an online database, such as a mapping database, weather database, calendar, a database of previous measurements, etc. to be included in the analysis.

According to some embodiments, for an identified fault, the method and/or monitoring system may include outputting a prediction of when the identified fault is likely to lead to failure in the container and/or associated component, may be based, at least in part, on the generated model.

According to some embodiments, predicting when a failure is likely to occur in the container and/or associated component may be based, at least in part, on expected future environmental parameters.

According to some embodiments, the mode of failure may include at least one of a change in dimension, a change in position, a change in color, a change in texture, change in size, a change in appearance, a fracture, a structural damage, a crack, crack size, critical crack size, crack location, crack propagation, change in orientation, a specified pressure applied to the container and/or associated component, a change in the movement of one component in relation to another component, an amount of leakage, a rate of leakage, change in rate of leakage, amount of accumulated liquid, a change in the amount of accumulated liquid, size of formed bubbles, change in amount of evaporation, etc. or any combination thereof.

According to some embodiments, for an identified fault and/or trend, the method and/or monitoring system include, if the identified change is not classified as being associated with a mode of failure, storing and/or using data associated with the identified change for further investigation, wherein the further investigation may include at least one of adding a mode of failure, updating the algorithm configured to identify the change, and training the algorithm to ignore the identified change in the future, thereby improving the algorithm configured to identify the change.

According to some embodiments, obtaining data associated with characteristics of at least one mode of failure of the container and/or associated component may include data associated with a location of the mode of failure on the structure, and/or a specific type of mode of failure.

According to some embodiments, obtaining data associated with characteristics of at least one mode of failure of the container and/or associated component may include receiving input data from a user.

According to some embodiments, for an identified fault and/or trend, the method and/or monitoring system may include analyzing received signal(s) and wherein obtaining data associated with characteristics of at least one mode of failure of the container and/or associated component includes automatically retrieving the data from a database, based, at least in part, on the received signal(s) from at least one optical sensor. Optionally, the monitoring system may retrieve data on one or more environmental parameters from an online database, such as a mapping database, weather database, calendar, a database of previous measurements, etc. to be included in the analysis.

According to some embodiments, obtaining data associated with characteristics of at least one mode of failure of the container and/or associated component may include identifying a previously unknown failure mode by applying the received signals to a machine learning algorithm configured to determine a mode of failure of the container and/or associated component.

According to some embodiments, identifying the at least one change in the signals may include analyzing raw data of the received signals.

According to some embodiments, the at least one signal may include at least one image, a portion of an image, a set of images, a video, or a video frame.

According to some embodiments, identifying the at least one change in the signals includes analyzing dynamic movement of the container and/or associated component, wherein the dynamic movement may include any one or more of linear movement, rotational movement, vertical motion, periodic (repetitive) movement, oscillating movement, damage, defect, cracking, fracture, change in orientation, change in acceleration, cut, warping, inflation, deformation, abrasion, wear, corrosion, oxidation, a change in dimension, a change in position, change in size, or any combination thereof.

According to some embodiments, for an identified fault and/or trend, the method and/or monitoring system may include outputting data associated with an optimal location for placement of the optical sensor, from which potential modes of failure can be detected.

According to some embodiments, for an identified fault and/or trend, the method and/or monitoring system may include at least one illumination source configured to illuminate at least part of the container, associated component, liquid surface, or combination thereof, and wherein classifying whether the identified change in the signals may be associated with a mode of failure of the container and/or associated component may be based, at least in part, on any one or more of the placement(s) of the at least one illumination source, the duration of illumination, the wavelength, the intensity, the direction of illumination, and the frequency of illumination.

According to some embodiments, the monitoring system may be configured to generate at least one model of a trend in the identified fault and/or trend, wherein the trend may include a rate of change in the fault and/or trend.

According to some embodiments, the monitoring system may be configured to prevent failure of a structure by identifying a fault and/or trend in real time and monitoring the changes of the fault and/or trend in real time.

Reference is made to FIG. 6, which shows a schematic illustration of a system for monitoring potential failure in a container and/or associated component, in accordance with some embodiments of the present invention.

According to some embodiments, the monitoring system 600 for monitoring potential failure in a container and/or associated component may be configured to monitor a container and/or associated component, an associated component of a container, two or more associated components of a container, independent components of a container, interconnected components of a container, or any combination thereof.

According to some embodiments, the system 600 may include a container containing a liquid optically distinguishable from the container, and one or more optical sensors 612 configured to be mounted in or in sight of the container and/or associated component thereof. According to some embodiments, the system 600 may be configured to monitor the container in real time. According to some embodiments, the system 600 may include at least one processor 602 in communication with optical sensor(s) 612. According to some embodiments, the processor 602 may be configured to receive signals (or data) from optical sensor(s) 612. According to some embodiments, the processor 602 may include an embedded processor, a cloud computing system, or any combination thereof. According to some embodiments, the processor 602 may be configured to process the signals (or data) received from optical sensor(s) 612 (also referred to herein as the received signals or the received data). According to some embodiments, the processor 602 may include an image processing module 606 configured to process the signals received from optical sensor(s) 612.

According to some embodiments, optical sensor(s) 612 may be configured to detect light reflected off the liquid surface in the container. Optionally, the liquid in the container may be selected for high light and/or low light environments e.g., selection of a liquid that may absorb a very little light and/or may reflect more light, may thereby provide a clearer image. Moreover, by changing the wavelengths, intensity, and/or directions of the light, this phenomenon may be intensified. According to some embodiments, and as described in greater detail elsewhere herein, the monitoring system may include one or more illumination sources configured to illuminate the liquid surface in the container, the container and/or an associated component.

According to some embodiments, changing the direction of the light may include moving the illumination sources. According to some embodiments, changing the direction of the light may include maintaining the position of two or more illumination sources fixed, while powering (or operating) the illumination sources at different times, thereby changing the direction of the light that illuminates the liquid surface in the container, the container and/or an associated component. According to some embodiments, and as described in greater detail elsewhere herein, the monitoring system may include one or more illumination sources positioned such that operation thereof illuminates part or all of the liquid surface in the container, the container and/or an associated component. According to some embodiments, the monitoring system may include a plurality of illumination sources, wherein each illumination source is positioned at a different location in relation to the liquid surface in the container, the container and/or an associated component.

According to some embodiments, the wavelengths, intensity and/or directions of the one or more illumination sources may be controlled by the processor. According to some embodiments, changing the wavelengths, intensity and/or orientation of the one or more illumination sources thereby enables the detection of the liquid surface and/or selected dimensions on the liquid surface in the container, the container and/or an associated component. According to some embodiments, optical sensor(s) 612 may enable the detection of small variations in the level of the liquid surface in a container, volume of liquid and/or a change in a volume of liquid in a container, by analyzing the images, which may be invisible to the naked eye.

According to some embodiments, optical sensor(s) 612 may include a camera. According to some embodiments, optical sensor(s) 612 may include an electro-optical sensor. According to some embodiments, optical sensor(s) 612 may include any one or more of a charge-coupled device (CCD) and a complementary metal-oxide-semiconductor (CMOS) sensor (or an active-pixel sensor), or any combination thereof.

According to some embodiments, optical sensor(s) 612 may include any one or more of a point sensor, a distributed sensor, an extrinsic sensor, an intrinsic sensor, a through beam sensor, a diffuse reflective sensor, a retro-reflective sensor, or any combination thereof.

According to some embodiments, the optical sensor(s) may include one or more lenses and/or a fiber optic sensor. According to some embodiments, the one or more optical sensor may include a software correction matrix configured to generate an image from the obtained data. According to some embodiments, the optical sensor(s) may include a focus sensor configured to enable the optical sensor to detect changes in the obtained data. According to some embodiments, the focus sensor may be configured to enable the optical sensor to detect changes in one or more pixels of the obtained signals.

According to some embodiments, the system 600 may include one or more user interface modules 614 in communication with the processor 602. According to some embodiments, the user interface module 614 may be configured for receiving data from a user, wherein the data is associated with any one or more of the container and/or associated component, the type of container and/or associated component, the type of system in which the container and/or associated component operates, the mode(s) of operation of a container and/or associated component, the user(s) of the container and/or associated component, one or more environmental parameters, one or more modes of failure of the container and/or associated component, or any combination thereof. According to some embodiments, the user interface module 614 may include any one or more of a keyboard, a display, a touchscreen, a mouse, one or more buttons, or any combination thereof. According to some embodiments, the user interface 614 may include a configuration file which may be generated automatically and/or manually by a user. According to some embodiments, the configuration file may be configured to identify the at least three dimensions and/or level of liquid in the container and/or associated component. According to some embodiments, the configuration file may be configured to enable a user to mark and/or select the at least three dimensions.

According to some embodiments, the system 600 may include a storage module 604 configured to store data and/or instructions (or code) for the processor 602 to execute. According to some embodiments, the storage module 604 may be in communication (or operable communication) with the processor 602. According to some embodiments, the storage module 604 may include a database 608 configured to store data associated with any one or more of the system 600, the structure, user inputted data, one or more training sets (or data sets used for training one or more of the algorithms), or any combination thereof. According to some embodiments, the storage module 604 may include one or more algorithms 610 (or at least one computer code) stored thereon and configured to be executed by the processor 602. According to some embodiments, the one or more algorithms 610 may be configured to analyze and/or classify the received signals, as described in greater detail elsewhere herein. According to some embodiments, and as described in greater detail elsewhere herein, the one or more algorithms 610 may include one or more preprocessing techniques for preprocessing the received signals. According to some embodiments, the one or more algorithms 610 may include one or more machine learning models.

According to some embodiments, the one or more algorithms 610 may include a change detection algorithm configured to identify a change in the received signals. According to some embodiments, the one or more algorithms 610 and/or the change detection algorithm may be configured to receive signals from optical sensor(s) 612, obtain data associated with characteristics of at least one mode of failure of the structure, and/or identify at least one change in the received signals.

According to some embodiments, the one or more algorithms 610 may include a classification algorithm configured to classify the identified change. According to some embodiments, the classification algorithm may be configured to classify the identified change as a fault and/or trend. According to some embodiments, the classification algorithm may be configured to classify the identified change as a normal performance (or motion) of the container and/or associated component.

According to some embodiments, the one or more algorithms 610 may be configured to analyze the fault and/or trend (or the identified change classified as a fault and/or trend). According to some embodiments, the one or more algorithms 610 may be configured to output a signal (or alarm) indicative of the identified change being associated with the mode of failure.

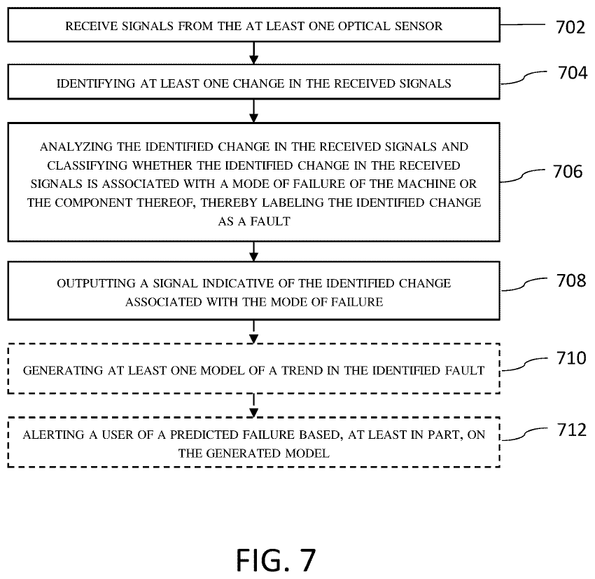

According to some embodiments, such as depicted in FIG. 7, the method may include signal acquisition 802, or in other words, receiving one or more signals. According to some embodiments, the method may include receiving one or more signals from at least one optical sensor fixed on or in vicinity of the container and/or associated component, such as, for example, one or more sensors 612 of system 600.

According to some embodiments, the one or more signals may include one or more images. According to some embodiments, the one or more signals may include one or more portions of an image. According to some embodiments, the one or more signals may include a set of images, such as a packet of images. According to some embodiments, the one or more signals may include one or more videos. According to some embodiments, the one or more signals may include one or more video frames. According to some embodiments, the method may include preprocessing (804) the one or more received signals. According to some embodiments, the preprocessing may include converting the one or more received signals into electronic signals (e.g., from optical signals to electrical signals). According to some embodiments, the preprocessing may include generating one or more images, the one or more sets of images, and/or one or more videos, from the one or more signals. According to some embodiments, the preprocessing may include dividing the one or more images, one or more portions of the one or more images, one or more sets of images, and/or one or more videos, into a plurality of tiles. According to some embodiments, the preprocessing may include applying one or more filters to the one or more images, one or more portions of the one or more images, one or more sets of images, one or more videos, one or more video frames and/or a plurality of tiles. According to some embodiments, the one or more filters may include one or more noise reduction filters.

According to some embodiments, the method may include putting together (or stitching) a plurality of signals obtained from two or more optical sensors. According to some embodiments, the method may include stitching a plurality of signals in real time.

According to some embodiments, the method may include applying the one or more received signals, the one or more images, the one or more portions of the one or more images, the one or more sets of images, and/or the one or more videos, to a change detection algorithm 808 (such as, for example, one or more algorithms 610 of system 600) configured to detect a change therein, or a value calculated based thereon, e.g., a plane, vector, angle, etc. According to some embodiments, the change detection algorithm may include one or more machine learning models 822.

According to some embodiments, the fault and/or trend may indicate that the container and/or associated component may need to be monitored, such as, for example, changing volume and/or rate of volume change, periodic changes in the volume and/or rate of volume change, re-occurring changes in the volume and/or rate of volume change, etc.

According to some embodiments, the method may include obtaining data associated with characteristics of at least one mode of failure of the container and/or associated component, or mode of failure identification 806. According to some embodiments, data associated with characteristics of at least one mode of failure of the container and/or associated component may include a type of mode of failure. According to some embodiments, data associated with characteristics of at least one mode of failure of the container and/or associated component may include a location or range of locations of the mode of failure on the structure and/or a specific type of mode of failure.

According to some embodiments, the mode of failure may include one or more aspects which may fail in the container and/or associated component. According to some embodiments, and as described in greater detail herein, the mode of failure may include a critical development of an identified fault and/or trend. According to some embodiments, the mode of failure may include any one of or more of a change in dimension, a change in position, a change in color, a change in texture, a change in size, a change in appearance, a fracture, a structural damage, a crack, crack size, critical crack size, crack location, crack propagation, change in orientation, change in acceleration, a specified pressure applied to the structure, a change in the movement of one component in relation to another component, defect diameter, cut, warping, inflation, deformation, abrasion, wear, corrosion, oxidation, an amount of leakage, a rate of leakage, change in rate of leakage, amount of accumulated liquid, rate of accumulation of liquid, change in rate of evaporation, size of formed bubbles, jets, liquid flow rate, liquid volume, change in shade, a change in appearance, or any combination thereof.

According to some embodiments, the method may include obtaining data associated with characteristics of at least one mode of failure of the container and/or associated component by receiving user input. According to some embodiments, the method may include obtaining data associated with characteristics of at least one mode of failure of the container and/or associated component by analyzing the received signals and detecting at least one change that may be associated with a mode of failure. According to some embodiments, the method may include obtaining data associated with characteristics of at least one mode of failure of the container and/or associated component by analyzing the received signals and detecting potential modes of failure. According to some embodiments, the method may include obtaining data associated with characteristics of at least one mode of failure of the container and/or associated component by analyzing the received signals and detecting one or more modes of failure which were previously unknown.

According to some embodiments, obtaining data associated with characteristics of at least one mode of failure of the container and/or associated component includes receiving input data from a user. According to some embodiments, the user may input data associated with the mode of failure of the container and/or associated component using the user interface module 614. According to some embodiments, the method may include monitoring the structure based, at least in part, on the received input data from the user. According to some embodiments, the user may input the type of failure mode of the container and/or associated component. According to some embodiments, the user may input the location of the failure mode. According to some embodiments, the user may identify one or more locations as likely to fail and/or develop a fault.

According to some embodiments, the method may include automatically obtaining data associated with characteristics of at least one mode of failure of the container and/or associated component. According to some embodiments, the method may include obtaining data associated with characteristics of at least one mode of failure of the container and/or associated component without user input. According to some embodiments, the method may include analyzing the received signal and automatically retrieving the data from a database, such as, for example, the database 608. According to some embodiments, the one or more algorithm 610 may be configured to identify one or more modes of failure, within the database, which may be associated with the identified change and/or trend of the received signals of an optical sensor observing a container and/or associated component configured to be mounted within or in sight of container and/or associated component. According to some embodiments, the method may include searching the database for possible failure modes of the identified change and/or trend. According to some embodiments, the method may include retrieving data from the database, wherein the data is associated with possible failure modes of the identified change and/or trend.

According to some embodiments, the method may include obtaining data associated with characteristics of at least one mode of failure of the container and/or associated component by identifying a previously unknown failure mode. According to some embodiments, identifying a previously unknown failure mode may include applying the received signals and/or the identified change and/or trend to a machine learning algorithm 824 configured to determine a mode of failure of the container and/or associated component. According to some embodiments, the machine learning algorithm 824 may be trained to identify a potential failure mode of the identified change and/or trend.

According to some embodiments, at step 704, the method may include identifying at least one change and/or trend in the received signals. According to some embodiments, the method may include applying the received signals to a change detection algorithm such as for example, change detection algorithm 808, configured to detect (or identify) at least one change and/or trend in the received signals.

According to some embodiments, identifying at least one change and/or trend in the signals may include identifying a change and/or trend in the rate of change in the signals. For example, the algorithm may be configured to identify a change and/or trend that occurs periodically within the analyzed signals, then the analyzed signals may “return” to the previous state (e.g., prior to the change in the analyzed signals). According to some embodiments, the algorithm may be configured to identify a change and/or trend in the rate of occurrence of the identified change and/or trend.

Advantageously, for monitoring of a container and/or associated component that may rotate, the analyzed signals received from an inclinometer and associated optical sensors positioned in the vicinity of the container and/or associated component may change periodically in correlation with the rotations of the container and/or associated component. Thus, and as described in greater detail elsewhere herein, for detecting a change in the container and/or associated component, the algorithm may detect first the periodical appearance of a change, while taking into account the rotations of the container and/or associated component.

Advantageously, for a monitoring of a container and/or associated component that may move linearly (e.g., up and down, left and right, etc.), such as, for example, an elevator or train, the analyzed signals received from an inclinometer and associated optical sensors positioned in the vicinity of the elevator may change periodically in correlation with the motion of the container and/or associated component. Thus, and as described in greater detail elsewhere herein, for detecting a change in the container and/or associated component, the algorithm may detect first the periodical appearance of a change, while taking into account the motion of the container and/or associated component.

According to some embodiments, the term “analyzed signals” as used herein may describe any one or more of the received signals, such as raw signals from the one or more optical sensor, processed or preprocessed signals from the one or more optical sensor, one or more images, one or more packets of images, one or more portions of one or more images, one or more videos, one or more portions of one or more videos, or any combination thereof. According to some embodiments, identifying the at least one change and/or trend in the analyzed signals may include analyzing raw data of the received signals.

According to some embodiments, the change detection algorithm 808 may include any one or more of a binary change detection, a quantitative change detection, and a qualitative change detection.

According to some embodiments, the binary change detection may include an algorithm configured to classify the analyzed signals as having a change or not having a change. According to some embodiments, the binary change detection may include an algorithm configured to compare two or more of the analyzed signals. According to some embodiments, for a comparison that shows the compared analyzed signals are the same, or essentially the same, the classifier labels the analyzed signals as having no detected (or identified) change. According to some embodiments, for a comparison that shows the compared analyzed signals are different, the classifier labels the analyzed signals as having a detected (or identified) change. According to some embodiments, two or more analyzed signals that are different may have at least one pixel that is different. According to some embodiments, two or more analyzed signals that are the same may have identical characteristics and/or pixels. According to some embodiments, the algorithm may be configured to set a threshold number of different pixels above which two analyzed signals may be considered as different.

Advantageously, the change detection algorithm 808 enables fast detection of changes in the analyzed signaling and may be very sensitive to the slightest changes therein. Even more so, the detection and warning of the binary change detection may take place within a single signal, e.g., within a few milliseconds, depending on the signal outputting rate of the optical sensor, or for an optical sensor comprising a camera, a within a single image frame, e.g., within a few milliseconds, depending on the frame rate of the camera.

According to some embodiments, the binary change detection algorithm may, for example, analyze the analyzed signals and determine if a non-black pixel changes to black over time, thereby indicating a possible change in the position of the structure, perhaps due to deformation or due to a change in the position of other components of the container and/or associated component. According to some embodiments, if the binary change detection algorithm detects a change in the signals, a warning signal (or alarm) may be generated in order to alert the equipment or a technician that maintenance may be required.

According to some embodiments, the binary change detection algorithm may be configured to determine the cause of the identified change using one or more machine learning models. According to some embodiments, the method may include determining the cause of the identified change by applying the identified change to a machine learning algorithm. For example, for a black pixel that may change over time (or throughout consecutive analyzed signals) to a color other than black, the machine learning algorithm may output that the change is indicative of a change in the material of the container and/or associated component, for example, due to overheating. According to some embodiments, the method may include generating a signal, such as an informational signal or a warning signal, if necessary. According to some embodiments, the warning signal may be a one-time signal or a continuous signal, for example, that might require some form of action in order to reset the warning signal.

According to some embodiments, the method may include identifying the at least one change in the signals by analyzing dynamic movement of the container and/or associated component. According to some embodiments, the dynamic movement may include any one or more of vertical motion, linear movement, rotational movement, periodic (repetitive) movement, oscillating motion, damage, defect, cracking fracture, structural damage, change in orientation, rotation, warping, inflation, deformation, abrasion, wear, corrosion, a change in dimension, a change in position, change in size, or any combination thereof.

According to some embodiments, the change detection may include a quantitative change detection. According to some embodiments, the quantitative change detection may include an algorithm configured to determine whether a magnitude of change above a certain threshold has occurred in the analyzed signals. According to some embodiments, the magnitude of change above a certain threshold may include a cumulative change in magnitude regardless of time, and/or a rate (or rates) of change in magnitude. For example, the value reflecting a change in magnitude may represent a number of pixels that have changed, a percentage of pixels that have changed, a total difference in the numerical values of one or more pixels within the field of view (or the analyzed signals), combinations thereof and the like. According to some embodiments, the quantitative change detection algorithm may output quantitative data associated with the change in the analyzed signals.

According to some embodiments, the change detection may include a qualitative change detection algorithm. According to some embodiments, the qualitative change detection algorithm may include an algorithm configured to classify the analyzed signals as depicting a change in the structure. According to some embodiments, the qualitative change detection algorithm may include a machine learning model configured to receive the analyzed signals and to classify the analyzed signals into categories including at least: including a change in the behavior of the container and/or associated component, and not including a change in the behavior of the container and/or associated component.

According to some embodiments, the change detection algorithm may be configured to analyze, with the assistance of a machine learning model, other more complex changes in the analyzed signals generated by the optical sensors. According to some embodiments, the machine learning model may be trained to recognize complex, varied changes. According to some embodiments, the machine learning model may be able to identify complex changes, such as, for example, for signals generated by the optical sensors that may begin to exhibit some periodic instability, such that the signals can appear normal for a time, and then abnormal for a time before appearing normal once again. Subsequently, the signals may exhibit some abnormality that is similar but different than before, and the change detection algorithm may be configured to analyze changes and, over time, train itself to detect the likely cause of the instability. According to some embodiments, the change detection algorithm may be configured to generate a warning signal or an informational signal, if necessary, for a user to notice the changes in the container and/or associated component.

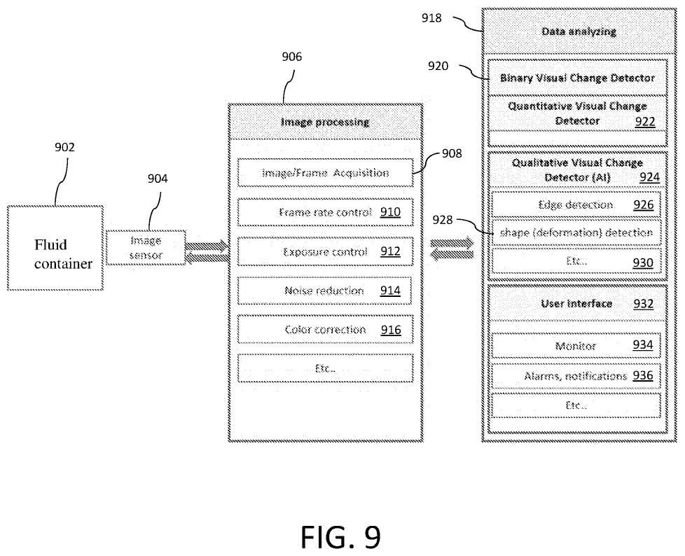

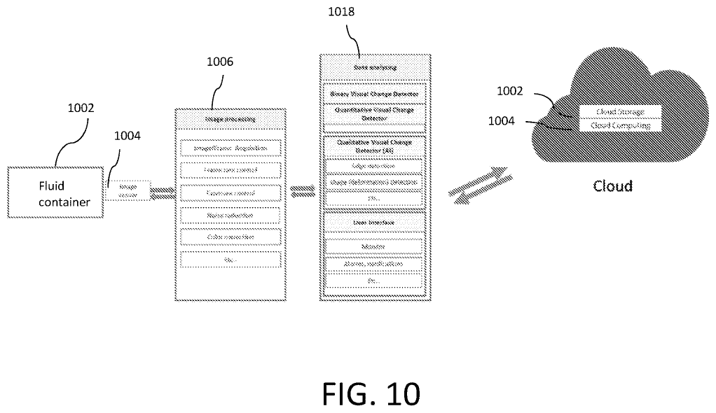

Reference is made to FIG. 9, which shows an exemplary schematic block diagram of the system for monitoring potential failure in a container and/or associated component, in accordance with some embodiments of the present invention, and to FIG. 10, which shows an exemplary schematic block diagram of the system for monitoring potential failure in a structure in communication with a cloud storage module, in accordance with some embodiments of the present invention.

As depicted in the exemplary monitoring systems of FIG. 9 and FIG. 10, the optical sensor may receive one or more signals from the container and/or associated component 902. According to some embodiments, the optical sensor may generate signals, such as, for example, images or video, and send the generated signals to an image processing module 906. According to some embodiments, the image processing module processes the signals generated by the optical sensor (or the image sensor 904 of FIG. 9 and FIG. 5), such that the data can be analyzed by the data analysis module 918 (or algorithms 610 as described herein). According to some embodiments, the image processing module 906 may include any one or more of an image/frame acquisition module 908, a frame rate control module 910, an exposure control module 912, a noise reduction module 914, a color correction module 916, and the like. According to some embodiments, the data analysis module (or algorithms 610 as described herein) may include the change detection algorithm such as for example, change detection algorithm 808. According to some embodiments, the user interface module 932 (described below) may issue any warning signals resulting from the signal analysis performed by the algorithms. According to some embodiments, any one or more of the signals, and/or the algorithms, may be stored on a cloud storage 1002. According to some embodiments, the processor may be located on a cloud, such as, for example, cloud computing 1004, which may co-exist with an embedded processor.

According to some embodiments, the data analyzing module 918 may include any one or more of a binary (visual) change detector 920 (or binary change detection algorithm as described in greater detail elsewhere herein), quantitative (visual) change detector 922 (or quantitative change detection algorithm as described in greater detail elsewhere herein), and/or a qualitative (visual) change detector 924 (or qualitative change detection algorithm as described in greater detail elsewhere herein). According to some embodiments, the qualitative (visual) change detector 924 may include any one or more of edge detection 926 and/or shape (deformation) detection 928. According to some embodiments, the data analyzing module 918 may include and/or be in communication with the user interface module 932. According to some embodiments, and as described in greater detail elsewhere herein, the user interface module 932 may include a monitor 934. According to some embodiments, the user interface module 932 may be configured to output the alarms and/or notifications 936/826.

According to some embodiments, the change detection algorithm such as for example, change detection algorithm 808, may be implemented on an embedded processor, or a processor in the vicinity of the optical sensor. Thus, the change detection algorithm such as for example, change detection algorithm 808, may enable a quick detection and prevent lag time associated with sending data to a remote server (such as a cloud).

According to some embodiments, once a change is identified using the change detection algorithm, the identified change may be classified using a classification algorithm. According to some embodiments, at step 706, the method may include analyzing the identified change in the received signals (or the analyzed signals) and classifying whether the identified change in the received signals is associated with a mode of failure of the container and/or associated component, thereby labeling the identified change as a fault and/or trend. According to some embodiments, the method may include applying the received signals (or the analyzed signals) to an algorithm configured to analyze the identified change in the received signals and to classify whether the identified change in the received signals is associated with a mode of failure of structure based, at least in part, on the obtained data.

According to some embodiments, the method may include applying the identified change to an algorithm configured to match between the identified change and the obtained data associated with the mode of failure. According to some embodiments, the algorithm may be configured to determine whether the identified change may potentially develop into one or more modes of failure. According to some embodiments, the algorithm may be configured to determine whether the identified change may potentially develop into one or more modes of failure based, at least in part, on the obtained data. According to some embodiments, the method may include labeling the identified change as a fault and/or trend if the algorithm determines that that identified change may potentially develop into one or more modes of failure. For example, an identified change of liquid surface level, volume of liquid and/or a change in a volume of liquid and/or a rate for change of a volume of liquid in a container may be identified as a fault and/or trend once the liquid surface level volume of liquid and/or a volume of liquid and/or a change in a volume of liquid and/or a rate for change of a volume of liquid in a container reaches a certain size that may be associated with a mode of failure that is a critical crack size or critical defect size.

For example, an identified change of liquid surface level, volume of liquid and/or a change in a volume of liquid and/or a rate for change of a volume of liquid in a container may be identified as a fault and/or trend once the liquid surface level, volume of liquid and/or a change in a volume of liquid and/or a rate for change of a volume of liquid in a container reaches a certain threshold that may be associated with a mode of failure that is critical.

For example, in an identified change of an increase in the rate of variation of liquid surface level, volume of liquid and/or a change in a volume of liquid and/or a rate for change of a volume of liquid in a container as a fault and/or trend once the rate of variation reaches a certain threshold that may be associated with a mode of failure that is critical.

According to some embodiments, the change in liquid surface level, volume of liquid and/or a change in a volume of liquid and/or a rate for change of a volume of liquid in a container may be associated with any one or more of structural damage, a crack, a defect, evaporation, leakage, rotation, warping, inflation, deformation, overheated engine and/or machine, blocked tubs and/or nozzles, open and/or leaked plugs, worn gasket and/or piston rings, linear movement, rotational movement, periodic (repetitive) movement, oscillating movement, a change in the rate of movement, or any combination thereof.

According to some embodiments, the change in liquid surface level, volume of liquid and/or a change in a volume of liquid and/or a rate for change of a volume of liquid in a container may be used to monitor and/or measure the liquid flow and/or consumption. Optionally, this may be analyzed to provide an indication of the condition of the machine using this liquid. For example, measuring an oil level in the container may be used to monitor the engine oil consumption. Which may be used to detect oil burning issues, malfunctioning (e.g., worn) valve seals, malfunctioning piston rings and/or leakages; measuring a coolant level in the container may be used to monitor a machine or system coolant consumption, e.g., high consumption may indicate an overheated machine, leakage of the cooling system, a damaged radiator, an open radiator cap, etc., while low consumption may indicate a blocked tubing and/or nozzles. According to some embodiments, the algorithm may identify the fault and/or trend using one or more machine learning models. According to some embodiments, and as described in greater detail elsewhere herein, the machine learning model may be trained over time to identify one or more faults and/or trends. According to some embodiments, the machine learning models may be trained to identify previously unknown faults and/or trends by analyzing a baseline behavior of the container and/or associated component.

Advantageously, identifying the fault and/or trend using a machine learning model enables the detection of different types of fault and/or trend, or even similar fault and/or trend that may appear different in different container and/or associated component and/or situations, or even different angles of the optical sensors. Thus, the machine learning model may increase the sensitivity of the detection of the one or more faults and/or trends.

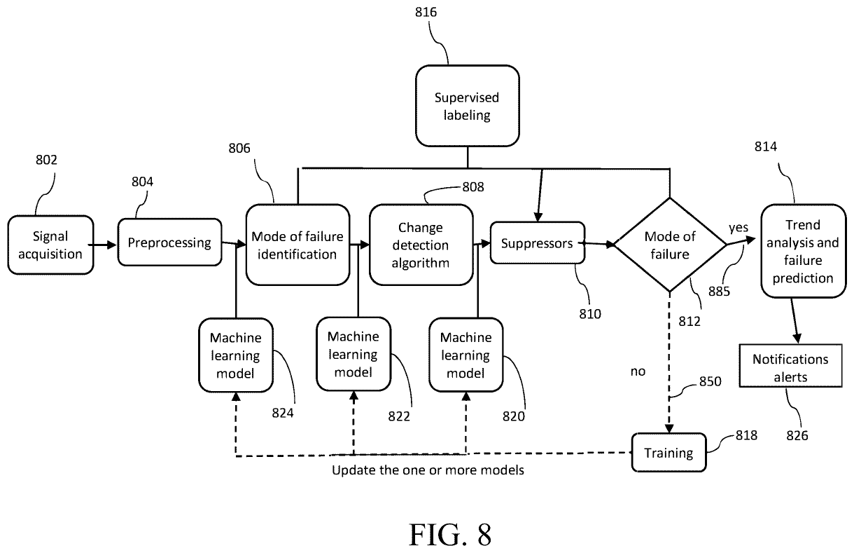

According to some embodiments, the monitoring system and/or the one or more algorithms may include one or more suppressor algorithms 810 (also referred to herein as suppressors 810). According to some embodiments, the one or more suppressor algorithms may be configured to classify the whether the detected fault and/or trend may develop into a failure or not, such as depicted by the mode of failure junction 812 of FIG. 8. According to some embodiments, the one or more suppressor algorithms 810 may include one or more machine learning models 820. According to some embodiments, the one or more suppressor algorithms 810 may classify a fault and/or trend as harmless.

According to some embodiments, at step 708, for an identified fault and/or trend, the method may include outputting a signal, such as a warning signal, indicative of the identified change being associated with the mode of failure. According to some embodiments, the method may include storing the identified change in the database, thereby increasing the data set for training the one or more machine learning models. According to some embodiments, the method may include labeling data associated with any one or more of the mode of failure identification 806, change detection algorithm 808, the suppressors 810, and the classification as depicted by the mode of failure junction 812. According to some embodiments, the method may include supervised labeling 816, such as manual labeling of the data using user input (or expert knowledge).

According to some embodiments, if the identified change is not classified as being associated with a mode of failure (such as depicted by arrow 850 of FIG. 8), it may be identified (or classified) as normal, or in other words, normal behavior or operation of the vehicle and/or container and/or associated component. According to some embodiments, for an identified change classified as normal, the method may include storing data associated with the identified change, thereby adding the identified change to the database and increasing the data set for training 818 the one or more machine learning models (such as, for example, the one or more machine learning models 820/822/824). According to some embodiments, the method may include using data associated with the identified change for further investigation, wherein the further investigation includes at least one of adding a mode of failure, updating the algorithm configured to identify the change, and training the algorithm to ignore the identified change in the future, thereby improving the algorithm configured to identify the change.

According to some embodiments, if the identified change is classified as being associated with a mode of failure (such as depicted by arrow 855 of FIG. 8), the method may include trend analysis and failure prediction 814. According to some embodiments, at step 710, the method may include generating at least one model of a trend. According to some embodiments, the method may include generating at least one model of the trend based on a plurality of analyzed signals. According to some embodiments, the method may include generating at least one model of the trend by calculating the development of the identified change within the analyzed signals over time. According to some embodiments, the trend may include a rate of change of the fault and/or trend. According to some embodiments, the method may include generating the at least one model of trend by calculating a correlation of the rate of change of the fault and/or trend with one or more environmental parameters. According to some embodiments, the one or more environmental parameters may include any one or more of temperature, season or time of the year, pressure, time of day, hours of operation of the structure, duration of operation of the container and/or associated component (e.g., age of the container and/or associated component, cycle time, run time, down time, etc.), an identified user of the container and/or associated component, GPS location, mode of operation of the container and/or associated component (e.g., continuous, periodic, etc.), and/or any combination thereof.

According to some embodiments, the mode of operation of the container and/or associated component may include any one or more of the distance the vehicle and/or container and/or associated component traveled or moved, the frequency of motion, the velocity of motion, the power consumption during operation, the changes in power consumption during operation, and the like. According to some embodiments, generating the at least one model of trend by calculating a correlation of the rate of change of the fault and/or trend with one or more environmental parameters may include taking into account the different influences in the surrounding of the container and/or associated component. According to some embodiments, the method may include mapping the different environmental parameters affecting the operation of the container and/or associated component, wherein the environmental parameters may vary over time. Optionally, the monitoring system may retrieve data on one or more environmental parameters from an online database, such as a mapping database, weather database, calendar, etc. to be included in the analysis.

According to some embodiments, at step 712, the method may include alerting a user of a predicted failure based, at least in part, on the generated model. According to some embodiments, the method may include outputting notifications and/or alerts 826 to the user. According to some embodiments, the method may include alerting a user of the predicted failure. According to some embodiments, the method may include alerting the user of a predicted failure by outputting any one or more of: a time (or range of times) of a predicted failure and characteristics of the mode of failure, or any combination thereof. According to some embodiments, the method may include outputting a prediction of when the identified trend is likely to lead to failure in the container and/or associated component, may be based, at least in part, on the generated model. According to some embodiments, the predicting of when a failure is likely to occur in the container and/or associated component may be based, at least in part, on known future environmental parameters. According to some embodiments, the predicting of when a failure is likely to occur in the container and/or associated component may be based, at least in part, on a known schedule, such as, for example, a calendar.

According to some embodiments, the system for monitoring potential failure in a container and/or associated component, such as, for example, system 600, may include one or more illumination sources configured to illuminate at least a portion of the liquid surface level, container and/or associated component. According to some embodiments, the one or more illumination sources may include any one or more of a light bulb, light-emitting diode (LED), laser, a fiber illumination source, fiber optic cable, and the like. According to some embodiments, the user may input the location (or position) of the illumination source, the direction of illumination of the illumination source (or in other words, the direction at which the light is directed), the duration of illumination, the wavelength, the intensity, and/or the frequency of illumination of the illumination source in relation to the one or more optical sensor. According to some embodiments, the one or more algorithms may be configured to automatically locate the one or more illumination sources. According to some embodiments, the one or more algorithms may instruct the operation mode of the one or more illumination sources. According to some embodiments, the one or more algorithms may instruct and/or operate any one or more of the illumination intensities of the one or more illumination sources, the number of powered illumination sources, the position of the powered illumination sources, and the wavelength, the intensity, and/or the frequency of illumination of the one or more illumination sources, or any combination thereof. Advantageously, an algorithm configured to instruct and/or operate the one or more illumination sources may increase the clarity of the received signals by reducing darker areas (such as, for example, areas from which light is not reflected and/or areas that were not illuminated) and may fix (or optimize) the saturation of the received signals (or images).

According to some embodiments, the one or more algorithms may be configured to detect and/or calculate the position in relation to the optical sensor(s), the duration of illumination, the wavelength, the intensity, and/or the frequency of illumination of the one or more illumination sources. According to some embodiments, the one or more algorithms may be configured to detect and/or calculate the position in relation to the optical sensor(s), the duration of illumination, the wavelength, the intensity, and/or the frequency of illumination of the one or more illumination sources based, at least in part, on the analyzed signals. According to some embodiments, the processor may control the operation of the one or more illumination sources. According to some embodiments, the processor may control any one or more of the duration of illumination, the wavelength, the intensity, and/or the frequency of illumination of the one or more illumination sources.

According to some embodiments, the method may include obtaining the position, the duration of illumination, the wavelength, the intensity, and/or the frequency of illumination, of the one or more illumination sources in relation to the optical sensor(s). According to some embodiments, the method may include obtaining the position of the one or more illumination sources via any one or more of a user input, detection, and/or using the one or more algorithms. According to some embodiments, the method may include classifying whether the identified change in the (analyzed) signals is associated with a mode of failure of the structure is based, at least in part, on any one or more of the placement(s) of the at least one illumination source, the duration of illumination, the wavelength, the intensity, and the frequency of illumination.

According to some embodiments, the method may include outputting data associated with an optimal location for placement (or location) of the one or more optical sensor, from which potential modes of failure can be detected. According to some embodiments, the one or more algorithms may be configured to calculate at least one optimal location for placement (or location) of the optical sensor(s), based, at least in part, on the obtained data, data stored in the database, and/or user inputted data.

According to some embodiments, the illumination source may illuminate the liquid surface level, container and/or component thereof with one or more wavelengths from a wide spectrum range, visible and invisible. According to some embodiments, the illumination source may include a strobe light, and/or an illumination source configured to illuminate in short pulses. According to some embodiments, the illumination source may be configured to emit strobing light without use of global shutter sensors.

According to some embodiments, the wavelengths may include any one or more of light in the ultraviolet region, the infrared region, or a combination thereof.

According to some embodiments, the one or more illumination sources may be mobile, or moveable. According to some embodiments, the one or more illumination sources may change the output wavelength during operation, change the direction of illumination during operation, change one or more lenses, and the like. According to some embodiments, the illumination source may be configured to change the lighting using one or more fiber optics (FO), such as, for example, by using different fibers to produce the light at different times, or by combining two or more fibers at once.

According to some embodiments, the fiber optics may include one or more illumination sources attached thereto, such as, for example, an LED. According to some embodiments, the light intensity and/or wavelength of the LED may be changed, as described in greater detail elsewhere herein, using one or more algorithms.

Advantageously, illuminating the liquid surface level, container and/or associated component may enable the optical sensor and/or processor to detect dimension of the container by analyzing shadows and/or reflections to ensure that the system has not been damaged and/or has a fault (e.g., leakage and/or evaporation of the liquid in the container, etc.). For example, a defect may generate a shadow that can be analyzed by the one or more algorithms and detected as a defect.

Advantageously, illuminating the container and/or associated component while receiving the optical signals from the optical sensor(s) may enable detection of changes and/or trends in the liquid surface level, volume of liquid and/or a change in a volume of liquid and/or a rate for change of a volume of liquid in a container that may not be visible to a human. According to some embodiments, the size of the change in the liquid surface level, volume of liquid and/or a change in a volume of liquid and/or a rate for change of a volume of liquid in a container may be less than about 25%, 20%, 15%, 10%, 5%, 3%, 1%, 0.5%, 0.25%. Each being a separate embodiment. According to some embodiments, the deviation of the liquid surface level, volume of liquid and/or a change in a volume of liquid and/or a rate for change of a volume of liquid in a container from a previously pre-determined or pre-calculated value may be less than about 25%, 20%, 15%, 10%, 5%, 3%, 1%, 0.5%, 0.25%. Each being a separate embodiment.

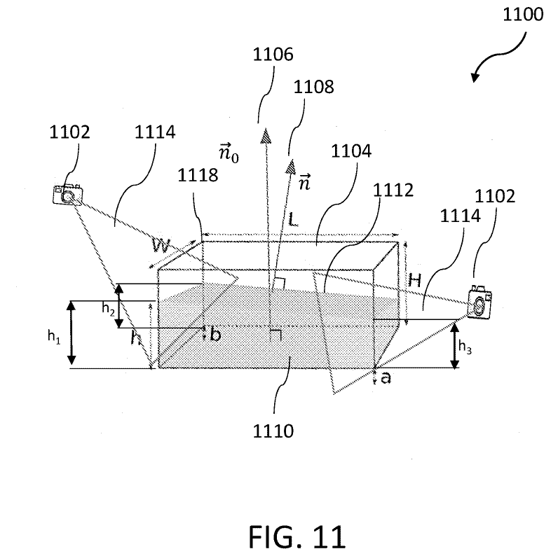

Reference is now made to FIG. 11, which is a simplified illustration of an exemplary container containing liquid having an surface angled relative to the container floor. A field of vision 1114 of the optical sensors 1102 may be sufficient to identify the liquid surface level and/or several dimensions points (e.g., at least three dimensions, such as h1, h2 and h3) such as the intersection of the surface of the liquid 1110 in the container 1104 with the walls 1118 of the container. Optionally, field of view 1114 may be sufficient to view all or some of parts of the container and/or be zoomed in to focus on one or more parts. From the dimensions, a liquid surface plane vector 1106 (normal to liquid surface plane 1112) may be calculated based on the liquid surface plane 1112. The orientation may be calculated from the deviation of the liquid surface plane vector 1106 from a vector normal to a horizontal plane 1108 of the container. Optionally, the height (h) of the liquid 1110 in the container 1104 may be measured relative to the height (H) of the container 1104. Optionally, the relative height of liquid 1110 in the container 1104 may provide an indication of the volume-of liquid in the container. Optionally, variations in the relative height of liquid 1110 in container 1104 may provide an indication of variations in the volume of liquid in the container. Optionally, variations in the relative height of the liquid 1110 in the container 1104 may provide an indication of the “health” of the container. Optionally, the container may be sealed (e.g., with a lid, cap, cover, cork, etc.). Optionally, the container may be sealed hermetically.

According to some embodiments, the container 1104 may have an undefined and/or amorphous shape whose volume can be calculated from its known data and/or a height (H), length (L) and width (W) which may be equal, different or a combination thereof. Optionally, the container may be any shape whose volume may be calculated, e.g., using the information from measurements, drawings, 3D files, etc.

According to some embodiments, the container may include a main vessel and a secondary vessel in fluid communication with each other. Optionally, the at least one of the optical sensor(s) may be positioned with a field of view of the secondary vessel.

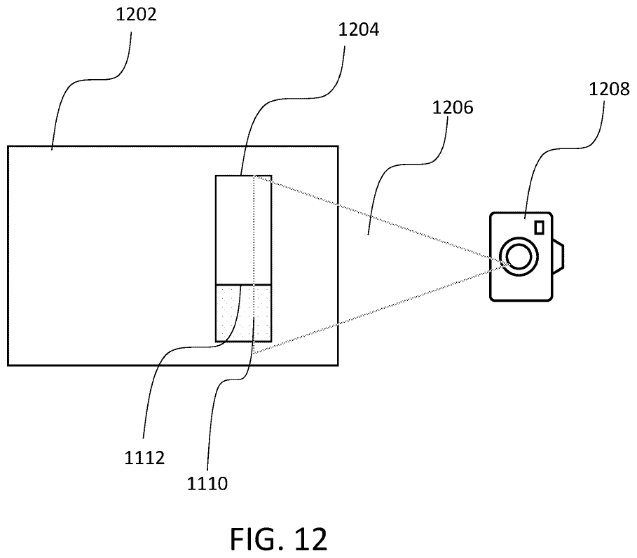

FIG. 12 is a simplified schematic illustration of a system for estimating liquid level, and therefrom liquid volume, in accordance with some embodiments of the present invention. Optical sensor 1208 is positioned such that its field of view 1206 passes through window 1204 of container 1202, such that the level of the liquid surface 1212 in of the liquid 1210 in the container 1202 may be determined.

FIG. 13 shows a schematic illustration of a system for estimating liquid level and therefrom liquid volume, in accordance with some embodiments of the present invention. For example, the container may include a main vessel 1302 and a secondary communicating vessel 1304 in fluid communication with each other. The liquid level 1310 in the secondary vessel 1304 may lie within the field of view 1306 of the at least one of the one or more optical sensors 1308. The liquid level 1310 in the secondary vessel 1304 is the same as the liquid level 1314 in the main vessel 1302, thereby allowing the liquid level 1314 of the liquid 1316 in the container to be determined. Optionally, the system may include one or more illumination sources. Optionally, the one or more illumination sources may be configured to illuminate the container, window, secondary vessel, or part thereof.

### GENERAL

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1.-49. (canceled)

50. A system for monitoring a liquid volume, comprising a processing circuitry configured to:
input at least one image of a liquid contained in a container from at least one optical sensor,
estimate, from said at least one image, a volume of said liquid in said container; and
output an indicator of a consistency of said estimated liquid volume with an expected liquid volume based on an analysis of said estimated volume of said liquid.

51. The system of claim 50, wherein said images are input from a plurality of optical sensors capturing images of said container with respective fields of view.

52. The system of claim 50, wherein said indicator comprises an assessment of a health of at least one of:
said container;
a machine utilizing said liquid;
a vehicle utilizing said liquid;
a mechanism utilizing said liquid;
a heating, ventilation and air conditioning (HVAC) system; and
a peripheral component.

53. The system of claim 50, wherein said indicator comprises at least one of:
said estimated liquid volume;
a rate of change of said liquid volume over time;
a prediction of a future liquid volume;
at least one of a frequency and an amplitude of a liquid fluctuation in the container;
a color change of said liquid;
a change in opacity of said liquid;
a change in clarity of said liquid;
a change in viscosity of said liquid;
a presence of particles in the liquid;
maintenance instructions;
a time to failure estimation;
a failure alert; and
operating instructions in response to a detected failure.

54. The system of claim 50, wherein said estimating comprises analyzing a distribution of intensities in at least one channel of said at least one image and identifying pixels having a distribution consistent with a presence of a liquid.

55. The system of claim 50, wherein said estimating comprises eliminating pixels distant from a main volume of said liquid from a calculation of said liquid volume.

56. The system of claim 50, wherein said estimating comprises calculating said liquid volume based on a geometrical analysis of a container shape.

57. The system of claim 50, wherein said estimating is based on a statistical analysis of a sequence of images.

58. The system of claim 50, wherein said estimating is further based on data obtained from non-optical sensors.

59. The system of claim 50, wherein said estimating is further based on data obtained from external sources.

60. The system of claim 50, wherein said analysis is based on a change of said liquid volume over time.

61. The system of claim 50, wherein said analysis is based on a trend analysis of changes in said liquid volume over time.

62. The system of claim 50, wherein said at least one image shows at least two sides of said container.

63. The system of claim 50, wherein said at least one image shows a section of said container, said section being wide enough to estimate a three-dimensional angle of said liquid relative to said container.

64. The system of claim 50, wherein said at least one optical sensor is configured to capture said at least one image while said container is in motion relative to the ground.

65. The system of claim 50, wherein said at least one optical sensor is located outside said container.

66. The system of claim 50, wherein said at least one optical sensor is located inside said container.

67. The system of claim 50, wherein said indicator is retrieved from a data structure using values of at least one of:
said estimated liquid volume;
a rate of change of said liquid volume over time;
a prediction of a future liquid volume; and
a prediction of a variation in said rate of change of said liquid volume over time.

68. The system of claim 50, wherein said analysis is based on a machine learning model trained with a training set comprising at least one of:
images collected during periods of usage of said liquid;
images collected during periods of non-usage of said liquid;
images collected of a similar container during periods of usage;
images collected of a similar container during periods of non-usage;
images collected of a different container in a similar machine during periods of usage;
images collected of a different container in a similar machine during periods of non-usage;
images of other components; and
non-image data associated with some or all of the images in the training set.

69. A computer-implemented method for monitoring a liquid volume, comprising:
receiving, by at least one processor, at least one image of a liquid contained in a container from at least one optical sensor;
estimating, by the at least one processor, from said at least one image, a volume of said liquid in said container; and
outputting, by the at least one processor, an indicator of a consistency of said estimated liquid volume with an expected liquid volume based on an analysis of said estimated volume of said liquid.
